(19) United States
(12) Patent Application Publication
(10) Pub. No.: US 2003/0056192 A1
(43) Pub. Date: Mar. 20, 2003

(54) Source code analysis system and method

(76) Inventor: Allen G. Burgess, W. Newton, MA (US)

Correspondence Address: ALLEN BLOOM, C/O DECHERT, PRINCETON PIKE CORPORATION CENTER, P.O. BOX 5218, PRINCETON, NJ, 08543-5218, US

(21) Appl. No.: 09/864,139

(22) Filed: May 24, 2001

(51) Int. Cl. G06F 7/00

(52) U.S. Cl. 717/100

(57) ABSTRACT

A preferred aspect of the invention concerns a system and method for analysis of source code. The system generally builds a database associated with a software application. The database content is generally derived from the application source code (e.g., program code, copybooks, includes and the like) and is preferably a relational database. A viewer provides access to the contents of the database (e.g., through graphical representations on a desktop PC). By specifying an application (with associated source code and control information) the invention is operable to display all relevant information, including module-to-module communication, calls made to databases or external files, and variable usage throughout the application.

The present invention relates to computer source code development and maintenance and in particular to a source code analysis system and method.

Information Technology based organizations are often faced with tasks related to the development and maintenance of complex software projects. Many companies not only develop complex software but also acquire software projects from other organizations. Every time a company acquires another organization, changes its business rules, externalizes operations onto the Web, or adapts to new industry regulations, to name a few examples, its internal IT operation must rapidly marshal resources to execute a successful software project reflecting those changes.

One problem facing IT organizations today is the scarcity of subject matter experts (SMEs)-programmers and analysts with detailed understanding of the organization's source code. This scarcity reflects IT industry trends:

programmers who originally wrote the source code are retired or departed;

programmers don't stay at the company long enough to fully absorb the code;

documentation is outdated or no longer exists;

software project/update work is outsourced to consultants new to the code; and

systems become more complex every day, encompassing multiple languages, making code more difficult to understand.

What is needed in the art, and provided by the invention, are improved systems and methods for allowing programmers and analysts to quickly and more accurately understand complex software applications that span multiple languages and platforms.

### SUMMARY OF THE INVENTION

The invention provides a source code analysis system and method. One aspect of the invention provides a system and method for analyzing at least one application comprised of at least one source code file. A parser is preferably operable to read the source code file and a relational database is operable to store data derived from the source code file. The parser is preferably operable to identify at least one of a variable, constant, command, instruction, function, database table or database field associated with the source code file. The parser is also preferably operable to quantify a role for each variable, constant, command, instruction, function, database table and database field identified in the source code file and to write data derived from the source code file in into the database.

In another aspect of the invention the parser is operable to quantify whether each variable, constant, command, instruction, function, database table and database field is at least one of a modifier, modified, used in a call, used as subscript, and used in a database query.

In another aspect of the invention the parser is operable to assign at least one of a use code, modification code and a flow code for each variable, constant, command, instruction, function, database table and database field identified in the source code file.

In another aspect of the invention at least one viewer is provided. The viewer is preferably operable to query the database, read query results and display information relating to at least a portion of the query results.

In another aspect of the invention the viewer is operable to display information relating to communication between at least two modules within the source code file.

In another aspect of the invention the viewer is operable to display information that isolates an individual source module from other source modules within the source code file.

In another aspect of the invention the viewer is operable to display the source code for at least one module within the source code file.

In another aspect of the invention the viewer is operable to display source code organized from different perspectives including at least two of procedures, paragraphs, copybooks, calls, and external files.

In another aspect of the invention the viewer is operable to display information relating to at least one variable recited in the source code file.

In another aspect of the invention the viewer is operable to display information relating to the structure of at least one group of variables within the source code file.

In another aspect of the invention the viewer is operable to display information relating to the use of at least one variable within the source code file.

In another aspect of the invention the viewer is operable to display information relating to at least one module based on different perspective including at least two of variable declarations, copybooks, external calls and files.

In another aspect of the invention the viewer is operable to display information associated with at least one module within the source code file based on at least one of a variable, paragraph, procedures, copybook, keyword, constant, command, database field and call.

In another aspect of the invention the viewer is operable to display information associated with at least one module within the source code file based on a variable name.

In yet another aspect of the invention the viewer is operable to display information associated with at least one module within the source code file based on a location of a variable within a group structure.

The invention provides a source code analysis system and method that captures source code in a natural way that does not require that users perform extra steps or additional processing.

One aspect of the invention provides a system having a load program, source retrieval program, a source file manager and a parser with an associated database.

In another aspect of the invention the load program is operable to initiate execution of the source retrieval program.

In another aspect of the invention the source retrieval program is operable to gather at least one source code file.

In another aspect of the invention the source retrieval program is operable to gather at least one source code file and transmit the source code file to the source file manager.

In another aspect of the invention the source file manager is operable to transmit the source code file to the parser.

In another aspect of the invention the parser is operable to read the source code file and write data derived from the source code file into the database.

In another aspect of the invention at least one viewer is operable to query the database, read query results and display information relating to at least a portion of the query results.

In another aspect of the invention the parser is operable to read the source code file and identify at least one of a variable, constant, command, instruction, function, database table and database field associated with the source code file, the parser being operable to quantify a role for each variable, constant, command, instruction, function, database table and database field identified in the source code file.

In another aspect of the invention the parser is operable to quantify whether each variable, constant, command, instruction, function, database table and database field is a modifier, modified, used in a call, used as subscript, and used in a database query.

### BRIEF DESCRIPTION OF THE DRAWINGS

FIG. 1 is a general block diagram of a system in accordance with the invention including a load program, source retrieval program, source file manager, parser, database and viewers in data communication;

FIG. 1a is a general block diagram of an exemplary load program in accordance with the invention;

FIG. 2 is a block diagram showing an exemplary relational database table relationship including tables storing information pertaining to Copybooks;

FIG. 3 is a block diagram showing an exemplary relational database table relationship including tables storing information pertaining to Commands;

FIG. 4 is a block diagram showing an exemplary relational database table relationship including tables storing information pertaining to Source Compiles;

FIG. 5 is a block diagram showing an exemplary relational database table relationship including tables storing information pertaining to Constants;

FIG. 6 is a block diagram showing an exemplary relational database table relationship including tables storing information pertaining to Data Communications;

FIG. 7 is a block diagram showing an exemplary relational database table relationship including tables storing information pertaining to Databases;

FIG. 8 is a block diagram showing an exemplary relational database table relationship including tables storing information pertaining to Expanded Source;

FIG. 9 is a block diagram showing an exemplary relational database table relationship including tables storing information pertaining to External/Internal Files;

FIG. 10 is a block diagram showing an exemplary relational database table relationship including tables storing information pertaining to Functions;

FIG. 11 is a block diagram showing an exemplary relational database table relationship including tables storing information pertaining to Modification Codes;

FIG. 12 is a block diagram showing an exemplary relational database table relationship including tables storing information pertaining to Operators;

FIG. 13 is a block diagram showing an exemplary relational database table relationship including tables storing information pertaining to Reserved Words;

FIG. 14 is a block diagram showing an exemplary relational database table relationship including tables storing information pertaining to Variables;

FIG. 15 is a block diagram showing an exemplary relational database table relationship including tables storing information pertaining to Languages;

FIG. 16 is a block diagram showing an exemplary relational database table relationship including tables storing information pertaining to Evaluations;

FIG. 17 is a flow chart showing a portion of the basic operation of a Parser in accordance with the invention;

FIG. 18 is a pictorial diagram showing an exemplary Viewer display window layout in accordance with the invention;

FIG. 19 is a pictorial diagram showing a portion of an exemplary Viewer display window illustrating the selection of a module to module communication display in accordance with the invention;

FIG. 20 is a pictorial diagram showing a portion of an exemplary Viewer display window showing a module to module communication display in accordance with the invention;

FIG. 21 is a pictorial diagram showing a portion of an exemplary Viewer display window showing an isolated module display in accordance with the invention;

FIG. 22 is a pictorial diagram showing a portion of an exemplary Viewer display window showing an Expanded Source Code view window in accordance with the invention;

FIG. 23 is a pictorial diagram showing portions of exemplary Viewer display windows illustrating the selection of different Expanded Source views in accordance with the invention;

FIG. 24 is a pictorial diagram showing portions of exemplary Viewer display windows showing a variable definition view and a corresponding Expanded Source view in accordance with the invention;

FIG. 25 is a pictorial diagram showing portions of exemplary Viewer display windows showing an additional variable definition view and a corresponding Expanded Source Code view in accordance with the invention;

FIG. 26 is a pictorial diagram showing portions of exemplary Viewer sub-menu operable to select the Copy, Find, Display Flow Diagram, Properties, Trace, Bookmark and/or Structure options in accordance with the invention;

FIG. 27 is a pictorial diagram showing portions of exemplary Viewer display windows showing a variable properties view and a corresponding Expanded Source Code view in accordance with the invention;

FIG. 28 is a pictorial diagram showing portions of exemplary Viewer display windows showing a group structure to which a variable belongs, including level and address and a corresponding Expanded Source Code view in accordance with the invention;

FIG. 29 is a pictorial diagram showing portions of exemplary Viewer display windows illustrating a trace display for a selected variable and corresponding Expanded Source Code views in accordance with the invention;

FIG. 30 is a pictorial diagram showing portions of an exemplary Viewer display window and menu illustrating report generation functions in accordance with the invention;

FIG. 31 is a pictorial diagram showing portions of exemplary Viewer display windows illustrating the selection of a paragraph listing in accordance with the invention;

FIG. 32 is a pictorial diagram showing portions of exemplary Viewer display windows illustrating navigation based on actual usage of a program element (e.g., an external call to FNLOAD) and a corresponding Expanded Source Code view in accordance with the invention;

FIG. 33 is a pictorial diagram showing portions of exemplary Viewer display windows illustrating searching across all source modules in an application in accordance with the invention;

FIG. 34 is a pictorial diagram showing portions of exemplary Viewer display windows illustrating variable search results and a corresponding Expanded Source Code view in accordance with the invention;

FIG. 35 is a pictorial diagram showing portions of exemplary Viewer display windows illustrating searching for a variable based on an address in accordance with the invention;

FIG. 36 is a pictorial diagram showing portions of exemplary Viewer display windows illustrating searching across multiple applications in accordance with the invention; and

FIG. 37 is a pictorial diagram showing portions of exemplary Viewer display windows showing multiple database search results and a corresponding Expanded Source Code view in accordance with the invention.

### DETAILED DESCRIPTION OF THE INVENTION

### Definitions

The following terms shall have, for the purposes of this application, the respective meanings set forth below.

Client: generally refers to a computer system or process that requests a service of another computer system or process (e.g., a “server”) using some kind of protocol and accepts the server's responses. A client is part of a client-server software architecture.

Copybook: generally refers to a common piece of source code designed to be copied into one or more source programs. The term is commonly used by COBOL programmers but is applicable to most mainframe languages. Copybooks are functionally equivalent to libraries (e.g., as used in conjunction with various IBM mainframe computers). Copybooks are also functionally equivalent to PL/I “INCLUDE” files and to C and C++ header files.

Database: generally refers to a collection of information stored for later retrieval. Traditional databases are organized by fields, records, and files. A field is a single piece of information; a record is one complete set of fields; and a file is a collection of records. The term “database” is used herein in its broadest sense (i.e., a collection of information) and is not limited to any particular structure or implementation.

Data network: generally refers to a group of two or more computer systems linked together in data communication. The term “data network” encompasses any type of wired or wireless computer network, independent of protocol, including local-area networks (LANs), wide-area networks (WANs) and networks of networks including the an intranet, extranet and the Internet.

HTML: generally stands for “Hyper-Text Markup Language”, the authoring language used to create documents on the World Wide Web. HTML defines the structure and layout of a Web document by using a variety of tags and attributes.

Load program: generally refers to software operable to call or otherwise initiate execution of the source retrieval program.

JCL: generally stands for “Job Control Language”, a script language used to control the execution of programs in various computer systems (typically mainframe batch and online systems, mid-range systems and complex client-server systems).

Module: generally refers to a piece of software. A module can be a stand-alone program and/or may form a part of one or more larger programs. Modules may be compiled separately (in compiled languages) and can provide an abstraction or information hiding mechanism so that a module's implementation can be changed without requiring any change to other modules. The term module as used herein is functionally equivalent to objects in an object-oriented language.

Parser: generally refers to software that is operable to read information relating to source code and separate source code data declarations from program logic after reading source code statements and/or program commands. The parser may also determine the role of variables, constant, operator, reserved word, function, file, and database table and field. Once the roles have been identified they are preferably entered into an appropriate table within a database.

Parsing: generally refers to reading information relating to source code and separating source code data declarations from program logic after reading source code statements and/or program commands. Parsing may also include determining the role of a variable, constant, operator, reserved word, function, file, and database table and field.

Query: generally refers to a request for information, including but not limited to a formal request to a database or search engine.

Query Results: generally refers to information returned in response to a query. Query results typically include a subset of information contained in the database. Query results may also include all of the information contained in the database or no information from the database (e.g., an error message or null).

Relational Database: A database generally built on a relationship model in which data is organized in tables. The set of names of the table columns is called the “schema” of the table. Data can be manipulated using a relational algebra. SQL is a standard language for communicating with and/or querying a database built on the relational model.

Server: generally refers to a program running on a computer that provides some service to other (e.g., client) programs. The connection between client and server is normally by means of message passing, often over a network, and uses some protocol to encode the client's requests and the server's responses.

Source Code: generally refers to program instructions in their original form. The term source code as used herein also encompasses runtime libraries, copybooks, include files, control information such as JCL files and the like. A programmer writes a program in one or more programming languages with source code stored in one or more files. In order to be executed by a computer, all of the various source code files must be subsequently translated into machine language (e.g., compiled, assembled, linked etc. etc.).

Source Code Information: generally refers to source code as defined above. Source code information can collectively refer to logic or business rules embedded in the source code as well as to additional information files (e.g., source code information files) generated by the source retrieval program.

Source File Manager: generally refers to software operable to receive source code from the source retrieval program. The source file manager is preferably operable to transfer the source code to the parser.

Source Retrieval Program: generally refers to software operable to gather source code for subsequent transmission to the source file manager.

SQL: generally refers to “structured query language”, a standardized query language for requesting information from a database.

Viewer: generally refers to software operable to access to the contents of an associated database (e.g., through graphical representations on a desktop PC).

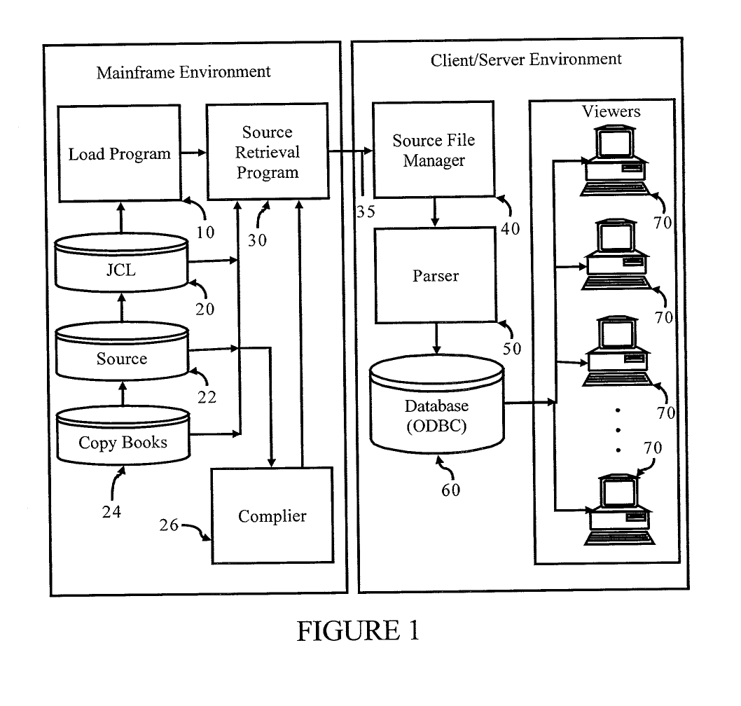

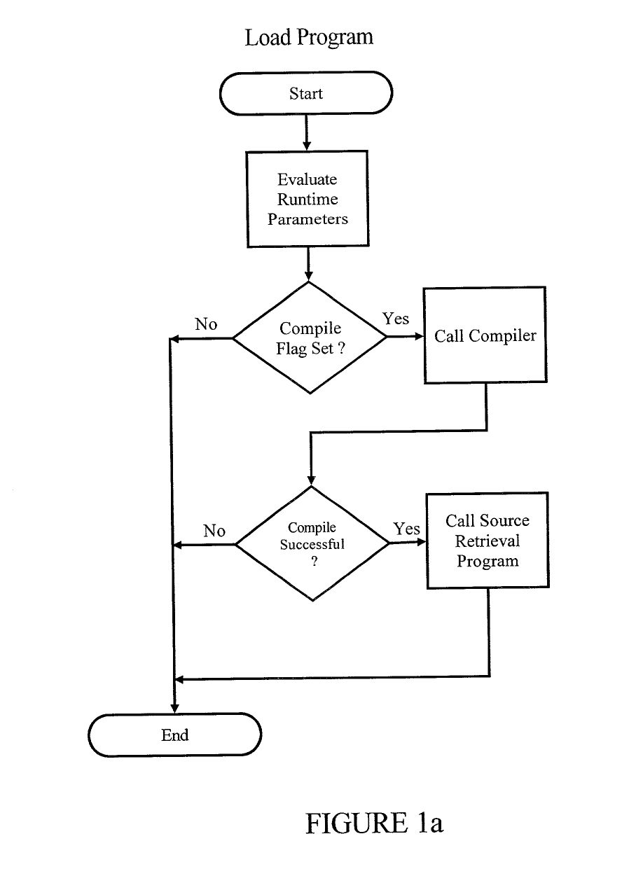

FIG. 1 shows a general block diagram of a source code analysis system in accordance with the invention. In a preferred embodiment, the invention generally has a load program 10, a source retrieval program 30, a source file manager 40, a parser 50, a database 60 and at least one viewer 70. The load program 10 and source retrieval program 30 generally gather source code including control information from various source code files, JCL files, copybooks and the like. The source code is generally associated with a particular computer program or application. The source retrieval program 30 preferably coordinates the source code information with the compiler output (symbol tables, debug information and the like).

The load program 10 and source retrieval program 30 work in concert to gather source code (e.g., from a main frame environment) for subsequent processing and database storage (e.g., in a client/server environment). In general, source code is retrieved from various source code files (including JCL files, copybooks and the like) both initially and on an ongoing basis. One aspect of the load program 10 and source retrieval program 30 is to capture source code in a natural way that does not require that users perform extra steps or additional processing. This is accomplished by linking the source retrieval process to the compilation process so that updated source modules and copybooks are captured as a natural byproduct of the program compilation/linking process. The information captured by the source retrieval program 30 is then parsed and processed as set forth in more detail below. The sending of updated source code information is preferably automatic and asynchronous with respect to normal compilation and linking processes so as to minimize delay.

There are several variations in which source code processing can be automatically tied to compilation via a load program 10, for example:

(1) The load program can be inserted into the compilation process ahead of the compiler to “see” the customer's library system the same way the compiler sees it, thereafter calling the source retrieval program to capture source code information and subsequently calling the compiler. Having the source retrieval program call the compiler is advantageous because it ensures that the source retrieval program cannot be skipped. This variation may also have the disadvantage that the source retrieval program may process and transmit to the source file manager (and ultimately the parser) source code that may not be compatible since prior to compilation its compatibility is not known. Accordingly, the parser is preferably enhanced with additional code, for example to be executed after compilation, to verify the compatibility of the source code generated or transferred by the source retrieval program with respect to the parser.

(2) For compilers that provide such a facility, the source retrieval program can be listed as a “preprocessor” in a list of preprocessors to be invoked by the language compiler itself. Thus, the load program 10 is generally provided by existing compiler functionality. This maximizes the tight coupling of the source retrieval program to the compiler and minimizes the impact on the customer's JCL or command language scripting, but it still has the disadvantage of generating or transferring source code information to the parser before the compatibility of the source code has been verified. It has the further disadvantage that relatively few of the commercially available compilers support this capability. Again, the parser is preferably enhanced with additional code, for example to be executed after compilation, to verify the compatibility of the source code generated or transferred by the source retrieval program with respect to the parser.

(3) In another variation, the source retrieval program can be executed after the compiler completes the compilation process. This can be accomplished by modifying the JCL or command language script to provide “load program” functionality and call or otherwise execute the source retrieval program. The source retrieval program must be directed (i.e., pointed back) to the JCL or command language scripting used for the compilation. This approach is advantageous in than the source retrieval program can easily be skipped if the compilation fails. This approach is also advantageous in that it can be used with compilers of any age, not just the latest ones that support a preprocessor list. This approach has the disadvantage that in some environments, reconstruction of the exact view of the library system or file system provided to the compiler can be difficult.

(4) In yet another variation, the load program can be implemented as a “dispatcher” program that is operable to call or otherwise execute the compiler and then source retrieval program. This approach is advantageous since source retrieval and compilation are carried out in the same operational step. This approach eliminates the problem of reconstructing the library view or file system view presented to the compiler since the compiler and the source retrieval program are presented with the same view. It is understood that the dispatcher program could alternatively call the source retrieval program first and the compiler second. The advantages and disadvantages of this of this variation are discussed above.

### Exemplary Source Retrieval Program Functionality

In a preferred embodiment, the load program 10 is implemented as a dispatcher program, written to call or otherwise initiate the compilation processes using technique (4) above. See FIG. 1a. The load program is preferably automatically operable to call (a) the compiler and (b) the source retrieval program. The source retrieval program gathers one or more source code files associated with a particular application and transfers these files to the source file manager. The transfer of source code files to the source file manager is preferably automatic. A runtime parameter can optionally be used to pass to the load program the following pieces of information: (1) whether or not compilation is required, and if so, the identity of the compiler, (2) other parameters required by the source retrieval program, and (3) any parameters supplied by the user that need to be passed to the compiler. In the alternative, these parameters can be passed via a text file, batch file or the like.

Preferably, the load program calls the compiler (or not) based on a compile flag that can be set (e.g., logic one) if compilation is desired or cleared (e.g., logic zero) if compilation is not desired. If compilation is performed, the load program then automatically invokes the source retrieval program and the source code is subsequently automatically transferred to the source file manager. In a preferred embodiment, the source retrieval program is called only if compilation succeeds. It is understood that FIG. 1a is a basic flowchart showing only rudimentary functionality of the load program. Additional functionality and processing can be included without departing from the invention. For example, the load program can include additional processing in the event the compile flag is cleared. The load program can also include additional error checking, debug or reporting information (e.g., in the case of a successful or unsuccessful compile). FIGS. 1 and 1a show the load program and source retrieval program as separate programs. It is understood that the load program and source retrieval program could be combined into a single piece of software providing the equivalent functionality without departing from the invention.

The source retrieval program 30 can include additional functionality. For example, the source retrieval program can open the various source files or programs 22, JCL files 20 or copybooks 24 and gather preliminary information. The source retrieval program can then output such information to a file (i.e., source code information file) for subsequent transfer to the source file manager. For example, the source retrieval program can detect source inclusion commands (programming language dependent) and save in the source code information file the identity of the copy/include library or libraries encountered 24, and the identity of each copybook or included member encountered. For each such pair encountered, the “copybook” (or “included member”) is preferably retrieved and processed like a source code file. The source code information file is subsequently sent to the parser, preferably as a single sequential file with all required source and copybook text and as much information as possible about the source file (e.g., where it came from) and each file copied into the source program (including header files).

Transmission of the source code information to the source file manager 40 is preferably performed automatically and asynchronously as shown generally by arrow 35. In a preferred embodiment, an FTP transfer is used to transfer information from the source retrieval program 30 to the source file manager 40. Communication between the source file manager 40 and source retrieval program 30 can be achieved by various methods and protocols including but not limited to off-line data storage devices such as disks, tape and the like as well as data transmission techniques such as modem, data networks via protocols such as FTP, TCP/IP, IBM's MQSeries, APPC and the like. The source file manager then transfers the unparsed source information to the parser. The source file manager and parser preferably interact on an automated basis such that parsing of transferred source code files occurs automatically.

The parser 50 generally reads the unparsed source information and separates source code data declarations from program logic and parses program commands. The parser preferably also determines the role of each variable, constant, operator, reserved word, function, file, and database table and field. Once the roles have been identified they are entered into the appropriate table within the database 60. Database 60 can be implemented with any suitable custom or commercial off-the-shelf relational, object oriented, or other database (e.g., Oracle version 8). Preferably, database 60 is implemented in accordance with the ODBC (Open DataBase Connectivity) standard. Alternatively, data used by invention may be stored in other memory structures, such as flat files, and data management functionality can be incorporated into the viewers 70.

Viewers 70 provide access to the contents of the database 60 (e.g., through graphical representations on a desktop PC). By specifying an application (with associated source code and control information) the invention is operable to present all relevant information, including module-to-module communication, calls made to databases or external files, and variable usage throughout the application. The gathering of this information is a required element of nearly all maintenance and system enhancement activities. Prior to the invention, however, programmers have utilized manual means to gather the same information and those means are both time consuming and error-prone.

The terms “display” and “present” and their formative are used interchangeably herein and encompass both visually displaying information to a user as well and playing audio and/or visual information to a user.

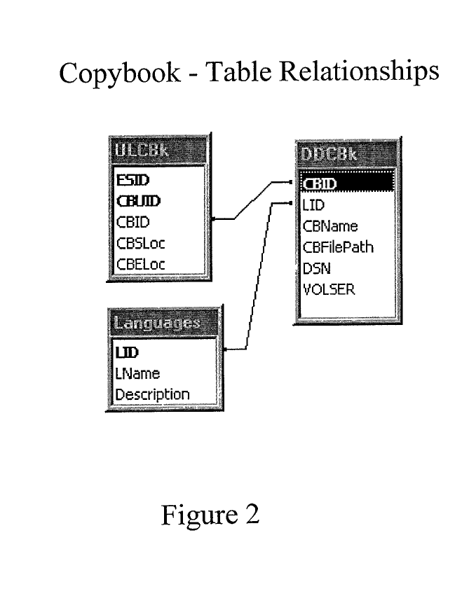

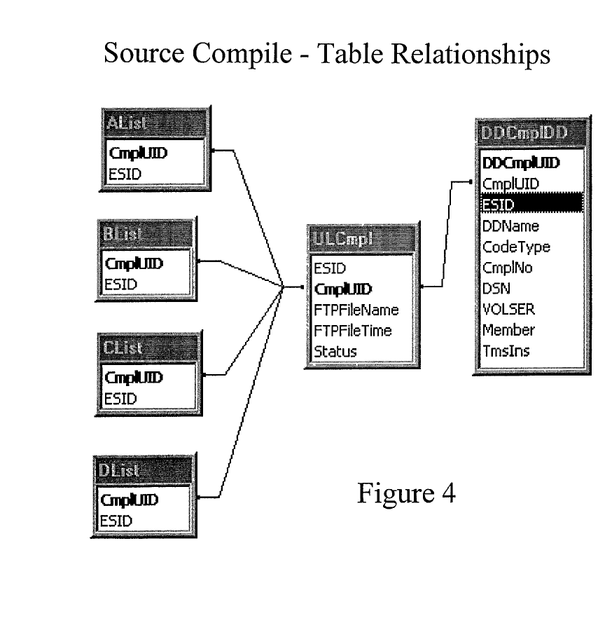

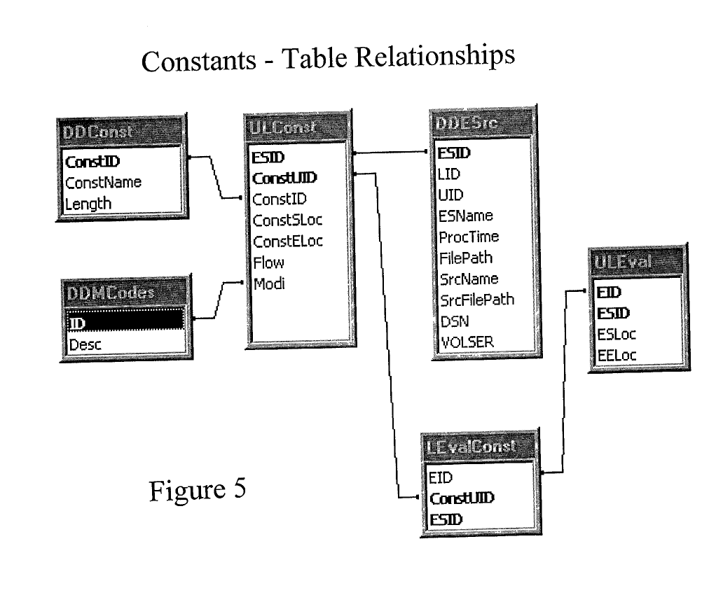

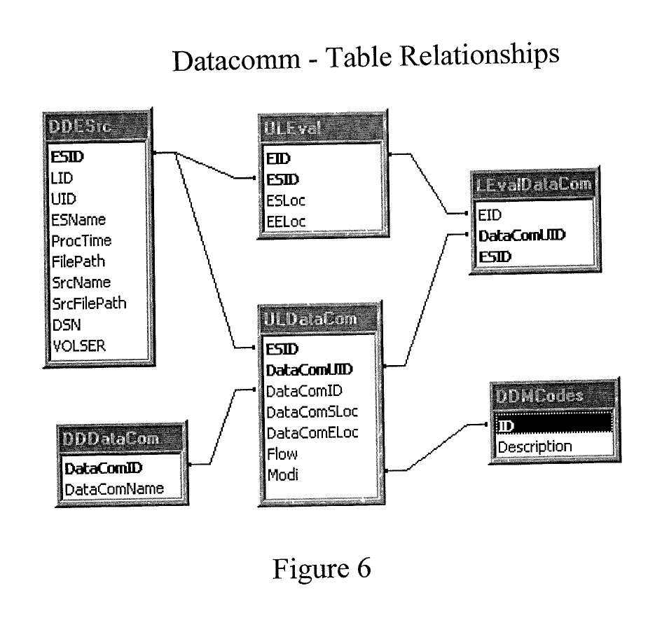

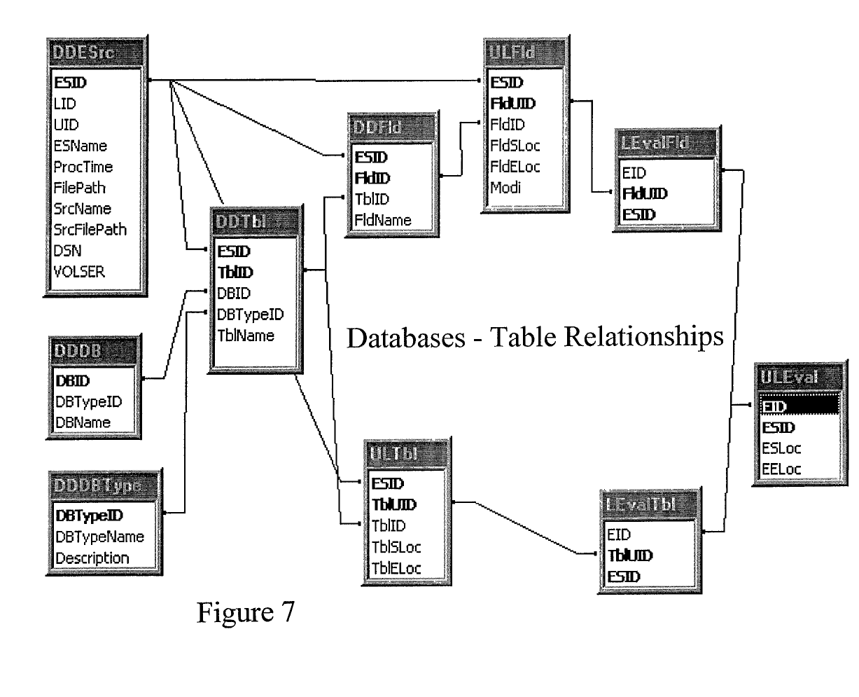

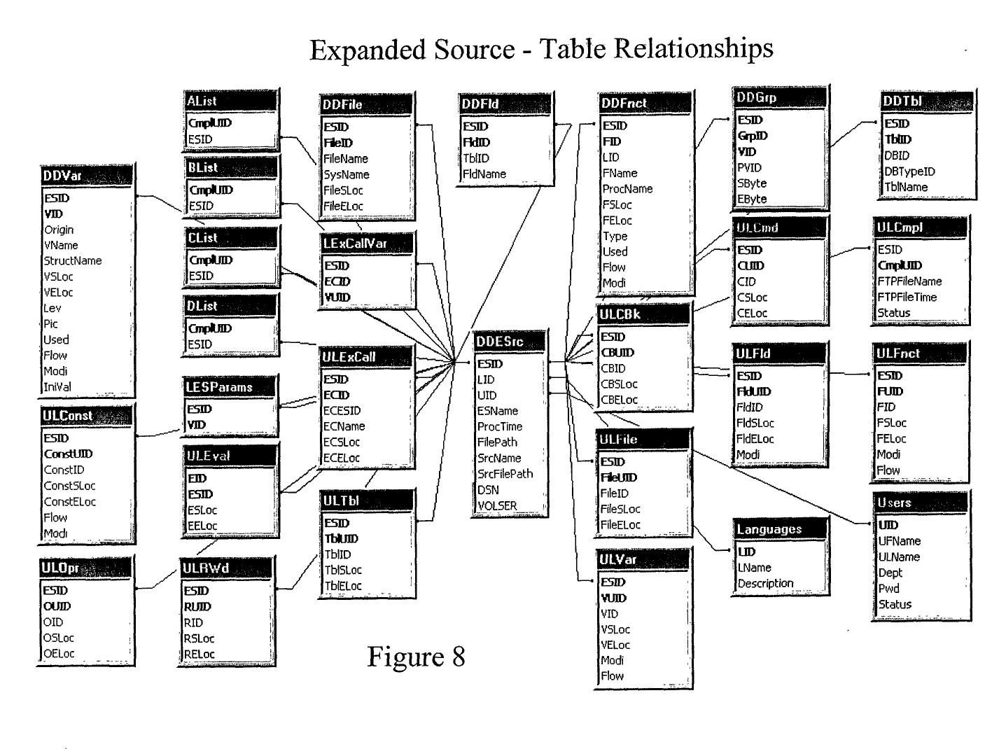

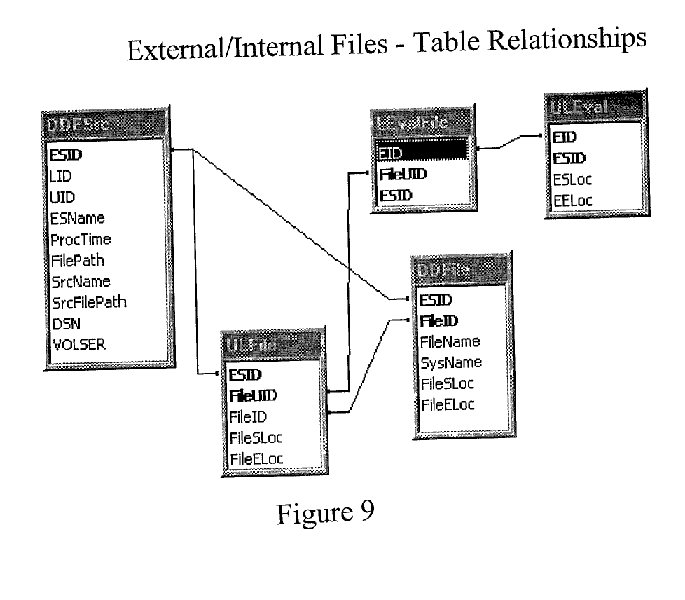

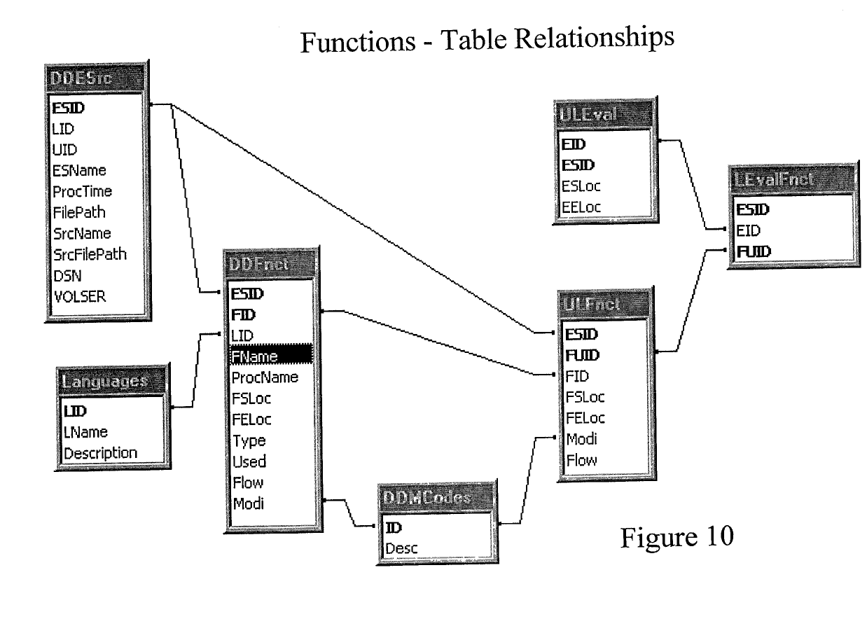

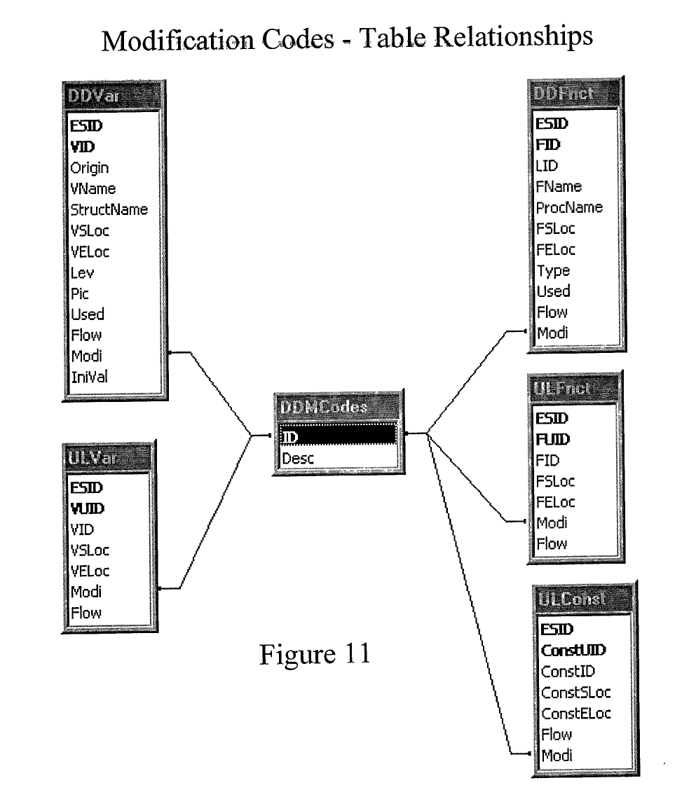

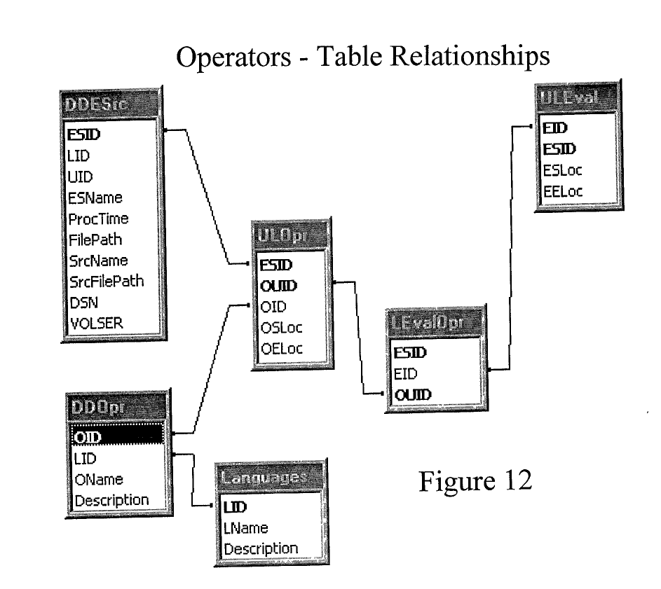

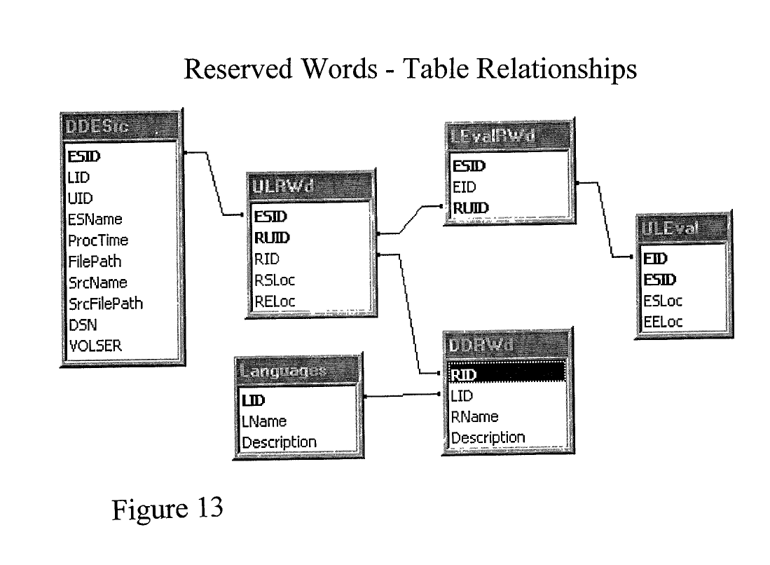

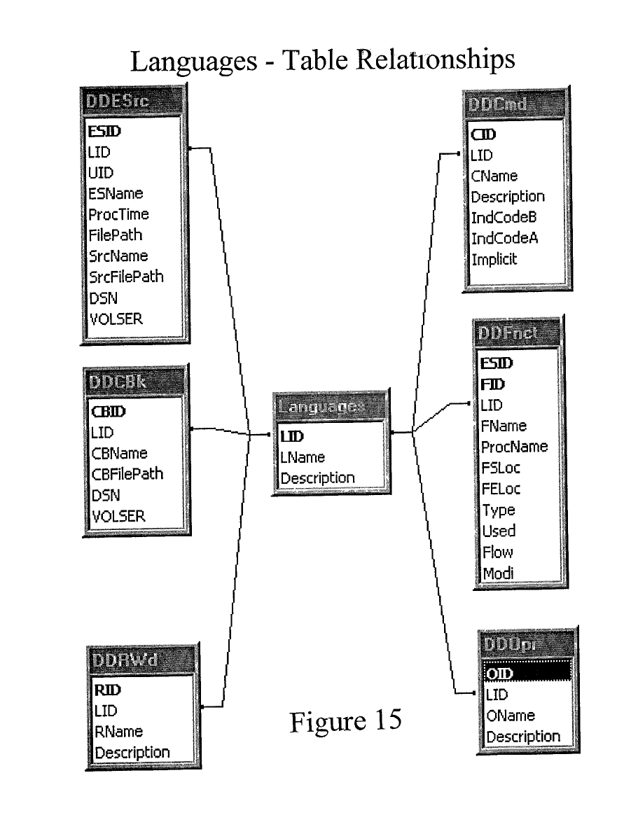

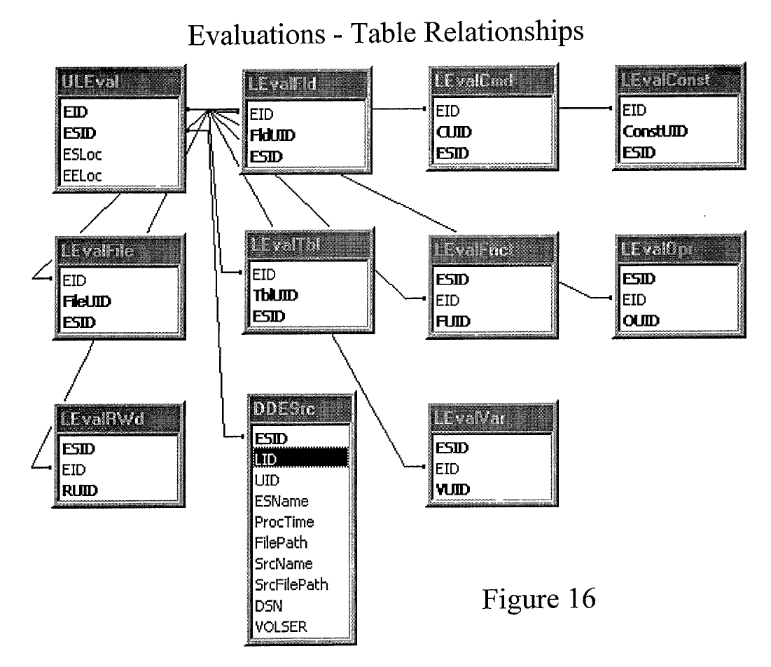

The invention generally builds a database associated with a particular application. The database contents are generally derived from the application source code (e.g., program code, copybooks, JCL file, includes and the like). The database 60 is preferably a relational database having three major types of tables: definitions (DD prefix), usage (UL prefix), and linkage (LE prefix). For example, a group of tables relating to variables (e.g., DDVar, ULVar and LEvalVar tables) will collectively store all the declarations unique to a specific expanded source file, every where the variable is used and how it is used, where the variable is redefined, what group structure it belongs to, the variable's role as a parameter in the linking of expanded source and the variable's use as a parameter in external calls. Table naming conventions, field names and descriptions of an exemplary database in accordance with the invention are set out below. See also Appendix A, B and C for field names and descriptions for the Data Definition tables, Usage List tables and Linkage tables respectively. Appendices D-F disclose exemplary language tables, use tables and compile tables in accordance with the invention. FIGS. 2-16 show the various relationships based on the type of information. Constructing database queries targeting specific information contained in the exemplary database structure as disclosed is readily apparent to those skilled in the art.

### Data Definition Tables

Data definition tables (DD prefix) are used to define things like variable declarations as well as specifics about the variable declaration including the start and end location within the source, the declaration level, whether or not it's used in flow control, how it effects other variables etc. Most of the information stored in a given Data Definition table defines the one-side information used to define a variable that can be referenced from a many side related table.

For example, the Data Definition table for variables, DDVar, defines variables that can be referenced from a many sided usage list table for variables, ULVar. See generally Tables 1 and 2 below for a description of the DDVar and ULVar table elements. The two tables are linked on the VID field, which in DDVar combines with an ESID to create a unique record of a specific variable declaration within a specific source file.

The DDVar.ESID foreign key links DDVar to DDESrc, which is a definition table of expanded source that has ESID as primary key. Two of the fields in DDVar (DDVar.Flow and DDVar.Modi) are dynamic and continue to update the coded information on the one side based on the cumulative values that get collected for the many side table ULVar.

In a preferred embodiment, the database has the following Data Definition tables: DDDataCom, DDCBk, DDCmd, DDDB, DDDBtype, DDESrc, DDFile, DDFld, DDFnct, DDGrp, DDMCodes, DDOpr, DDRDvar, DDRWd, DDTbl, DDVar. See Appendix A for exemplary Data Definition table field names and descriptions in accordance with the invention.

Table 1 below shows the exemplary field names and descriptions for the DDVar table.

TABLE 1

| DDVar - Field Name | Description |
|---|---|
| ESID | The identification code for the expanded |
| | source file containing the Variable |
| VID | The identification code for the variable |
| Origin | The location within the expanded source or |
| | copy book containing the variable |
| | definition |
| Vname | The name of the variable |
| VSLoc | The starting location within the source |
| | code where the variable is declared |
| VELoc | The ending location of the variable within |
| | the source code |
| Lev | The level code of the variable |
| Pic | The data type of the variable |
| Used | Code indicating if the variable is used |
| | within the logic of the source code |
| Flow | Code indicating the number of times the |
| | variable is to control program logic flow |
| | times |
| Modify | Code indicating the total “role” of the |
| | variable in the source code |
| InitVal | The initial value of the variable |

### Usage List Tables

The Usage List tables are the many side of a one to many relationship with the corresponding one side table. In the case of variables (as discussed above) the corresponding data definition table is DDVar and the related UL table is ULVar. ULVar contains all of the many side records needed to describe each usage of the variable through all the expanded source files in the database.

Table 2 below contains exemplary field names and descriptions for the ULVar table.

TABLE 2

| ULVar - Field Name | Description |
|---|---|
| ESID | The identification code for the expanded |
| | source file containing the Variable |
| VID | The identification code for the variable |
| VuID | The identification code for the particular |
| | usage of the variable |
| VSLoc | The starting location within the source |
| | code where the variable is used |
| VELoc | The ending location of the variable within |
| | the source code |
| Flow | Code indicating the number of times the |
| | variable is to control program logic flow |
| | times |
| Modify | Code indicating the total “role” of the |
| | variable in the source code |

Accordingly, each variable preferably has a plurality of fields (e.g., 12) associated with it in the DDVar Data Definition table and a plurality of fields (e.g., 7) associated with it in the ULVar Use List table. The invention preferably utilizes specific codes in association with the Used, Modify and Flow fields for some aspects of the source code (such as variables). A more detailed discussion of these codes is set out below.

In a preferred embodiment, the database has the following usage list tables: ULCbk, ULCmd, ULCmpl, ULConst, ULDataCom, ULEval, ULExCall, ULFile, ULFId, ULOpr, ULRWd, ULTbl, ULVar. See also Appendix B for field names and descriptions for the Usage List tables.

### Linkage Tables

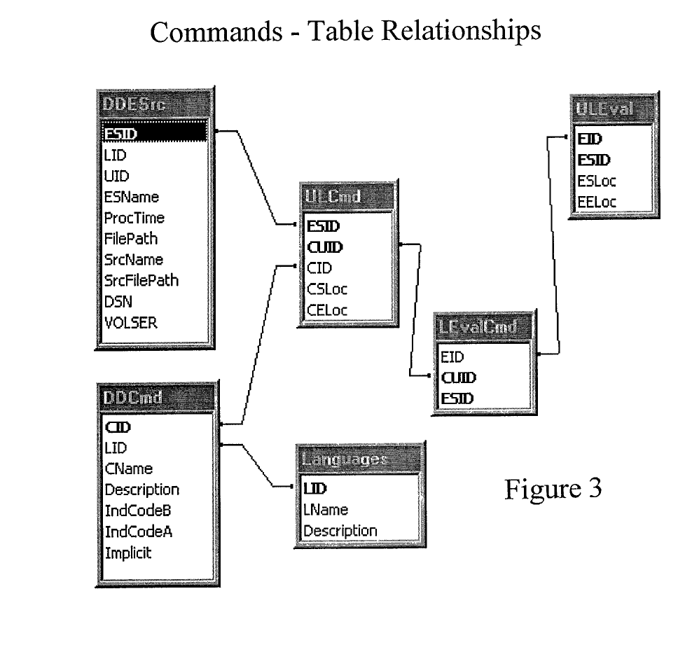

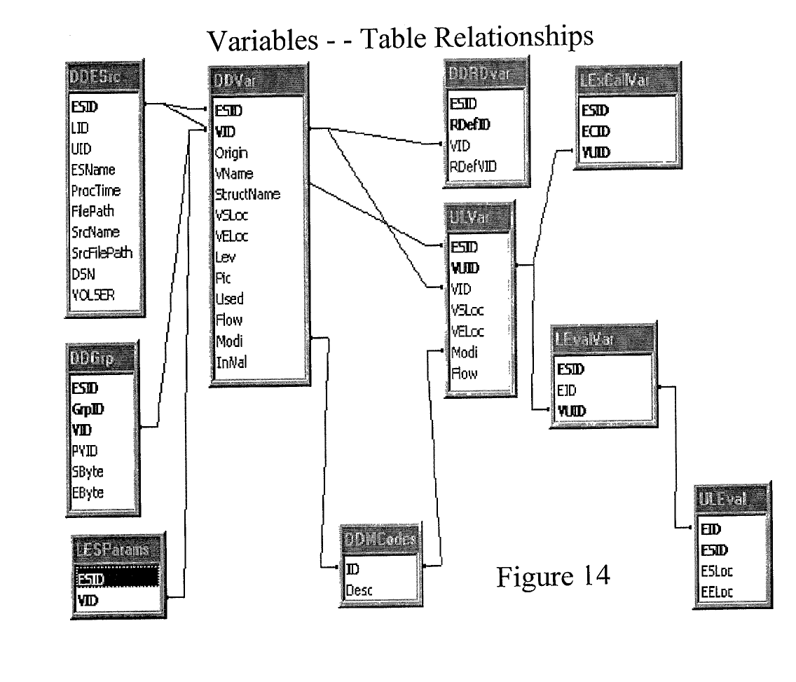

The Linkage Evaluation tables (LEVal prefix) create a many to many relationship between ULEval and the corresponding UL table. For example, LEvalVar links the usage information from the ULVar table to the ULEval table. See e.g., FIG. 14. Similarly, LEvalCmd links the usage information from the ULCmd table to the ULEval table. See e.g., FIG. 3. This relationship in the case of a variable, allows for unique identification of a specific variable usage within the context of a code evaluation. ULEval contains the starting and ending location of each evaluation in all expanded source. It also contains keys that relate it to the DDESrc table as well as each linkage table.

### Languages Table

The Languages table generally stores information regarding the different languages used in the source code. In a preferred embodiment, the database has a single languages table. See Appendix D for exemplary Languages table field names and descriptions in accordance with the invention.

### Users Table

The User table generally stores information regarding one or more users. In a preferred embodiment, the database has a single Users table. See Appendix E for exemplary Users table field names and descriptions in accordance with the invention.

### Compile Tables

The compile tables generally store information relating all compiled source code, copybooks and the like. In a preferred embodiment, the database has the following compile tables: DDCmplDD, Alist, Blist, Clist and Dlist. See Appendix F for exemplary Compile table field names and descriptions in accordance with the invention.

### Database Table Relationships

As discussed above, many of the tables in the exemplary database structure are related by one or more keys. FIGS. 2-16 show the relationships between the various tables with respect to different types of information. Based on the Schema disclosed in Appendices A-F and the relationships shown in FIGS. 2-16, it is submitted that the requisite queries for retrieving desired information from the exemplary database are readily apparent to those skilled in the art.

### Usage Codes

As stated above, the invention preferably utilizes specific codes in association with the Used, Modify (Modi) and Flow fields for some aspects of the source code (e.g., a variable). These codes collectively quantify a given program element's effect within an application's source code. The Use code generally indicates whether the variable is used within the logic of the source code. For example, the Use code in the variable definition table is preferably assigned the value Yes or No so as to indicate if the variable is used in the procedure or program logic or just declared and not used in logic.

### Flow Codes

Flow codes generally indicate whether a program element (e.g., a variable) is used in logic flow control. Preferably ULVar.Flow is assigned values 0 or 1 (No or Yes) depending upon whether or not the variable in question is used in flow control in a given usage. The same field in DDVar (DDVar.Flow) gets incremented each time a variable with the same variable identification code or VID (the linking field in ULVar) is found to be used in flow control. Assume for example, that the variable “WC06-EDIT-CHAR-1” is used in the expanded source file “cpnsrt.cxr” 34 times and out of these 34 uses of the variable, 32 of them effect flow control. Therefore, the value for DDVar.Flow in the record with an ESID (the identification code for the expanded source file containing the variable) that matches the expanded source file “cpnsrt.cxr” (19) and the VID that matches the variable “WC06-EDIT-CHAR-1” (778) will be 32 to represent the cumulative number of times it's reported in ULVar as used in flow control.

### Modification Codes

Modification codes (i.e., stored in Modi fields) generally indicate the role of the variable in the source code. The value of a given DDVar.Modi field differs from ULVar.Modi field in that it represents a logical definition based on cumulative values added to the ULVar.Modi field. The result is a modification code identifier in DDVar.Modi that is the logical result of all the ULVar.Modi values for a given VID of a given ESID.

There are four basic roles a variable, constant, function, database table or database field can have: modification, used in a call, used as subscript, and used in a database query. Variables can be part of variable (group) structures. When a member element of a structure is modified the structure is modified. Conversely when an element of a structure is used to modify another comparable element in another structure the structure is being used as a modifier.

Table 3 below shows an exemplary relationship between the Flow code and the Modify code in connection with the DDVar table. As discussed above, the Flow code in the DDVar table represents the number of times the variable is used in flow control.

TABLE 3

| Flow (n > 0) | Modify Code and Description |
|---|---|
| n | 0 = Used to control flow n times and not modified or |
| | modifier |
| n | 1 = Used to control flow n times and Modified only |
| n | 2 = Used to control flow n times and Modifier only |
| n | 3 = Used to control flow n times and Modifier and modified |
| n | 4 = Used to control flow n times and Call and not modified |
| | or modifier |
| n | 5 = Used to control flow n times and Call and modified |
| n | 6 = Used to control flow n times and Call and modifier |
| n | 7 = Used to control flow n times and Call, modifier, & |
| | modified |
| n | 8 = Used to control flow n times and Subscript and not |
| | modified or modifier |
| n | 9 = Used to control flow n times and Subscript and |
| | modified |
| n | 10 = Used to control flow n times and Subscript and |
| | modifier |
| n | 11 = Used to control flow n times and Subscript, |
| | modifier, & modified |
| n | 12 = Used to control flow n times and Query and not |
| | modified or modifier |
| n | 13 = Used to control flow n times and Query and modified |
| n | 14 = Used to control flow n times and Query and modifier |
| n | 15 = Used to control flow n times and Query, modifier, & |
| | modified |
| n | 16 = Used to control flow n times and Call, Subscript and |
| | not modified or modifier |
| n | 17 = Used to control flow n times and Call, Subscript and |
| | modified |
| n | 18 = Used to control flow n times and Call, Subscript and |
| | modifier |
| n | 19 = Used to control flow n times and Call, Subscript |
| | modifier, & modified |
| n | 20 = Used to control flow n times and Call, Query and not |
| | modified or modifier |
| n | 21 = Used to control flow n times and Call, Query and |
| | modified |
| n | 22 = Used to control flow n times and Call, Query and |
| | modifier |
| n | 23 = Used to control flow n times and Call, Query |
| | modifier, & modified |
| n | 24 = Used to control flow n times and Subscript, Query |
| | and not modified or modifier |
| n | 25 = Used to control flow n times and Subscript, Query |
| | and modified |
| n | 26 = Used to control flow n times and Subscript, Query |
| | and modifier |
| n | 27 = Used to control flow n times and Subscript, Query, |
| | modifier, & modified |
| n | 28 = Used to control flow n times and Call, Subscript, |
| | Query and not modified or modifier |
| n | 29 = Used to control flow n times and Call, Subscript, |
| | Query and modified |
| n | 30 = Used to control flow n times and Call, Subscript, |
| | Query and modifier |
| n | 31 = Used to control flow n times and Call, Subscript, |
| | Query modifier, & modified |

Exemplary values for the Modify code for use in connection with the usage tables (e.g., ULVar as well as ULConst, and ULFld) are set out below in Table 4. Flow codes and Modify codes having values greater than 0 are preferably mutually exclusive in the ULVar Table. Modification codes 32 and greater are used exclusively in conjunction with the ULVar table.

TABLE 4

| Modification | |
|---|---|
| Code Value | Description |
| 0 | Not modified or modifier (used in Compare) |
| 1 | Modified only |
| 2 | Modifier only |
| 3 | Both Modifier and Modified |
| 4 | Used in Call but Not Modifier or Modified |
| 5 | Used in Call and Modifier |
| 6 | Used in Call and Modifier |
| 7 | Used in Call and both Modifier and Modified |
| 8 | Used as Subscript only |
| 9 | Used as Subscript and Modified only |
| 10 | Used as Subscript and Modifier only |
| 11 | Used as Subscript and Modified and Modifier |
| 12 | Used in Database Query |
| 13 | Used in Database Query and is Modified (Read equivalent) |
| 14 | Used in Database Query and is Modifier (Write equivalent) |
| 15 | Used in Database Query and is Modified and Modifier |
| 16 | Used in Call and Subscript |
| 17 | Used in Call and Subscript and Modifier |
| 18 | Used in Call and Subscript and Modifier |
| 19 | Used in Call and Subscript and both Modifier and Modified |
| 20 | Used in Call and Database Query |
| 21 | Used in Call and Database Query and Modified |
| 22 | Used in Call and Database Query and Modifier |
| 23 | Used in Call and Database Query and both Modifier and |
| | Modified |
| 24 | Used as Subscript and Database Query |
| 25 | Used as Subscript and Database Query and Modified |
| 26 | Used as Subscript and Database Query and Modifier |
| 27 | Used as Subscript and Database Query and both Modifier |
| | and Modified |
| 28 | Used as Subscript and in Call and Database Query |
| 29 | Used as Subscript and in Call and Database Query and |
| | Modified |
| 30 | Used as Subscript and in Call and Database Query and |
| | Modifier |
| 31 | Used as Subscript and in Call and Database Query and both |
| | Modifier and Modified |
| 32 | Structure Element modified Structure Variable not used |
| 33 | Structure Element modified Structure Variable modified |
| 34 | Structure Element modified Structure Variable modifier |
| 35 | Structure Element modified Structure Variable modified |
| | and modifier |
| 36 | Structure Element modified Structure Variable used in Call |
| 37 | Structure Element modified Structure Variable used in Call |
| | and modified |
| 38 | Structure Element modified Structure Variable used in Call |
| | and modifier |
| 39 | Structure Element modified Structure Variable used in Call |
| | and modified and modifier |
| 44 | Structure Element modified Structure Variable in query |
| 45 | Structure Element modified Structure Variable in query and |
| | modified |
| 46 | Structure Element modified Structure Variable in query and |
| | modifier |
| 47 | Structure Element modified Structure Variable in query and |
| | modified and modifier |
| 52 | Structure Element modified Structure Variable in call and |
| | query |
| 53 | Structure Element modified Structure Variable in call and |
| | query and modified |
| 54 | Structure Element modified Structure Variable in call and |
| | query and modifier |
| 55 | Structure Element modified Structure Variable in call and |
| | query and modified and modifier |
| 64 | Structure Element used Structure Variable not used |
| 65 | Structure Element used Structure Variable modified |
| 66 | Structure Element used Structure Variable modifier |
| 67 | Structure Element used Structure Variable modified and |
| | modifier |
| 68 | Structure Element used Structure Variable used in Call |
| 69 | Structure Element used Structure Variable used in Call and |
| | modified |
| 70 | Structure Element used Structure Variable used in Call and |
| | modifier |
| 71 | Structure Element used Structure Variable used in Call and |
| | modified and modifier |
| 76 | Structure Element used Structure Variable in query |
| 77 | Structure Element used Structure Variable in query and |
| | modified |
| 78 | Structure Element used Structure Variable in query and |
| | modifier |
| 79 | Structure Element used Structure Variable in query and |
| | modified and modifier |
| 84 | Structure Element used Structure Variable in call and query |
| 85 | Structure Element used Structure Variable in call and query |
| | and modified |
| 86 | Structure Element used Structure Variable in call and query |
| | and modifier |

Codes 32, 33, 36, 40, 44, 48, 52, 56, and 60 represent the roll up in the DDVar table and 32 is used to indicate that some element in the structure was used to modify another structure in the ULVar Table. All structure elements in the fully qualified name that have the element modified will also receive modification code 1 indicating they have been modified.

Preferably, the Modify codes in the ULVar and ULConst Tables can only have the owing shown in Table 5 below:

TABLE 5

| ULVar Modify | | ULConst Modify | |
|---|---|---|---|
| Code Value | Description | Code Value | Description |
| 0 | Not modified or | 0 | Not modified or |
| | modifier (used in | | modifier (used in |
| | Compare) | | Compare) |
| 1 | Modified only | 1 | N/A |
| 2 | Modifier only | 2 | Modifier only |
| 3 | Modifier and | 3 | N/A |
| | modified | | |
| 4 | Used in Call | 4 | Used in Call |
| 5 | Modified by Call | 5 | N/A |
| 6 | Modifier in a Call | 6 | Modifier in a Call |
| 7 | N/A | 7 | N/A |
| 8 | Subscript only | 8 | Subscript only |
| 9 | Subscript of a | 9 | Subscript of a |
| | modified variable | | modified variable |
| 10 | Subscript of a | 10 | Subscript of a |
| | modifier variable | | modifier variable |
| 11 | Subscript of | 11 | Subscript of |
| | modifier and | | modifier and |
| | modified variable | | modified variable |
| 12 | Query only | 12 | Query only |
| 13 | Modified by a | 13 | N/A |
| | Query | | |
| 14 | Modifier in a | 14 | Modifier in a |
| | Query | | Query |
| 15 | N/A | 15 | N/A |
| 16 | Subscript of a | 16 | Subscript of a |
| | Call variable | | Call variable |
| 17 | Subscript of a | 17 | Subscript of a |
| | Call modified | | Call modified |
| | variable | | variable |
| 18 | Subscript of a | 18 | Subscript of a |
| | Call modifier | | Call modified |
| | variable | | variable |
| 19 | N/A | 19 | N/A |
| 20 | N/A | 20 | N/A |
| 21 | N/A | 21 | N/A |
| 22 | N/A | 22 | N/A |
| 23 | N/A | 23 | N/A |
| 24 | Subscript of | 24 | Subscript of |
| | Query | | Query |
| 25 | Subscript of | 25 | Subscript of |
| | modified Query | | modified Query |
| | variable | | variable |
| 26 | Subscript of | 26 | Subscript of |
| | modifier Query | | modifier Query |
| | variable | | variable |
| 27 | N/A | 27 | N/A |
| 28 | N/A | 28 | N/A |
| 29 | N/A | 29 | N/A |
| 30 | N/A | 30 | N/A |
| 31 | N/A | 31 | N/A |

### The Parser

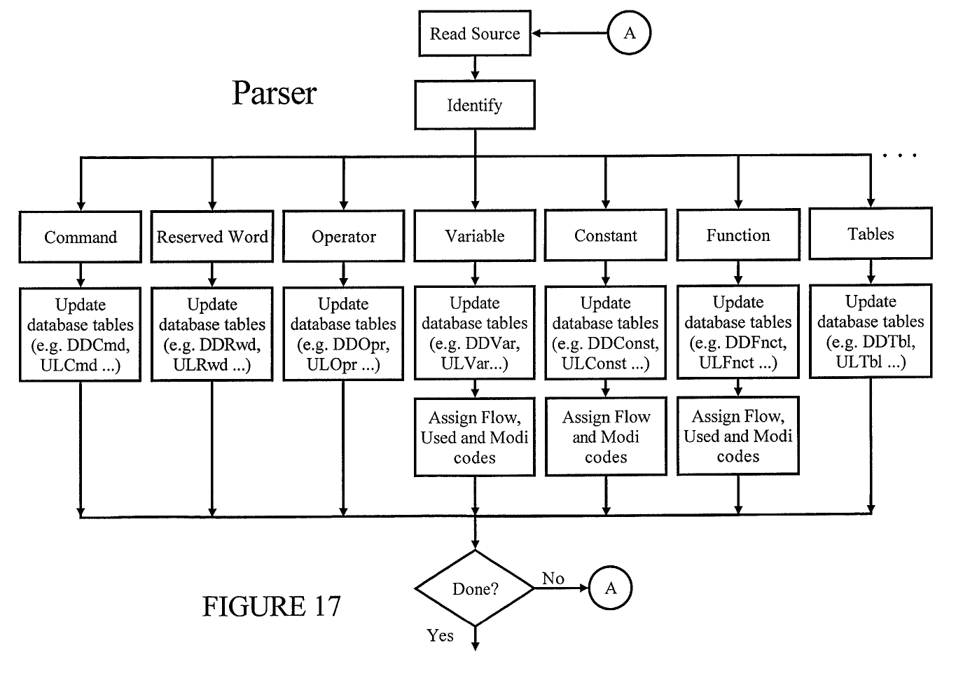

The parser 50 generally separates source code data declarations from program logic and parses program commands. FIG. 17 shows a simplified block diagram of a parser in accordance with the invention. After the source code is read by the parser and identified, the parser updates the database tables associated with each command, reserved word, operator, variable, constant, command, instruction, function, database table and the like. The parser also defines the role (e.g., modification, used in a call, used as subscript, and used in a database query) of each variable, constant, function, database table and database field. Once the roles have been identified they are also entered into the appropriate field and table within the database 60. Operation of the parser is best understood within the context of the following examples.

### SQL Parsing Examples

Regardless of a given source module's native language, the parser 50 recognizes any EXEC SQL instruction and populates the appropriate tables within the database 60. Variables within commands that read data into the application are designated as a modifier in the UL tables. Similarly, variables within commands that insert constants or update variables in one of the system's databases are designated as a modifier (again within the UL tables). The parsing and analysis of typical SQL commands is shown in the following example.

### EXAMPLE 1

This example relates to the declaring of a CURSOR. The parser analyzes each word in the instruction beginning with the command EXEC and ending with the semi-colon (or END-EXEC for COBOL). Exemplary Code is set out in Table 6 below.

TABLE 6

| Source Code | Line No. |
|---|---|
| EXEC SQL | 01394 |
| DECLARE RPTCSR CURSOR FOR | 01395 |
| SELECT * | 01396 |
| FROM ISO02.DMV00620 A | 01397 |
| WHERE FT_TBL_NUM = ‘500’ and | 01398 |
| FT_FORM_NUM = :HOLD_FORM_NUMBER AND | 01399 |
| (FT_STATUS = ‘X’ OR | 01400 |
| FT_STATUS = ‘H’); | 01401 |
| | 01402 |

The command EXEC (and END-EXEC for COBOL) is stored or entered in the command usage table (ULCmd). SQL, DECLARE, CURSOR, FOR, SELECT, FROM, and WHERE are entered in the reserved word usage table (ULRwd). , AND, and OR are entered in the operator use table (ULOpr). RPTCSR is entered in the DDVar table with a data definition of CURSOR, Flow code of 0, Use code of Yes, and Modify code of 4 (used in a “Call” and neither modified or modifier), and in the ULVar table with a Use code of Yes, Flow code of 0 and a Modify code of 4. The literal strings of ‘500’, ‘X’, and ‘H’ are entered in the ULConst table with a Flow code of 1 and Modify code of 4. The field names (FT_TBL_NUM, FT_FORM_NUM, FT_STATUS) will be entered into the ULFId table with Modify codes of 4. The table name, ISO02.DMV00620, will be entered into the DDThl and ULTbl tables and A will be stored as its alias. If this alias is used the table name will be substituted and entered into the ULTbl table. The declared variable, HOLD FORM NUMBER will be put into the ULVar table with a Flow code of 1 and a Modify code of 4. The Flow, Use and Modify codes for the variable HOLD-FORM-NUMBER in the DDVar table will be adjusted accordingly (Flow code incremented, Use code made a Yes, and a Modify Code for a summary of the number of roles played by HOLD_FORM_NUMBER (see Appendix B).

### EXAMPLE 2

Following this same schema, the next example is also straightforward. Exemplary Code is set out in Table 7 below:

TABLE 7

| Source Code | Line No. |
|---|---|
| | 01403 |
| EXEC SQL | 01404 |
| OPEN RPTCSR; | 01405 |
| | 01406 |
| EXEC SQL | 01686 |
| CLOSE RPTCSR; | 01687 |
| | 01688 |

The EXEC, OPEN, and CLOSE commands are entered into the ULCmd table and RPTCSR is entered into the ULVar table with a Flow code of 0 and a Modify code of 4.

### EXAMPLE 3

Exemplary Code is set out in Table 8 below:

TABLE 8

| Source Code | Line No. |
|---|---|
| | 01503 |
| EXEC SQL | 01504 |
| WHENEVER NOT FOUND CONTINUE; | 01505 |
| | 01506 |
| EXEC SQL | 01507 |
| WHENEVER SQL WARNING GO TO 1002-SQL-ERROR; | 01508 |
| | 01509 |
| EXEC SQL | 01510 |
| WHENEVER SQLERROR GO TO 1002-SQL-ERROR; | 01511 |
| | 01512 |

The EXEC command is entered into the ULCmd table and WHENEVER, NOT, FOUND and CONTINUE are entered into the ULRwd table. SQLWARNING and SQLERROR are entered into the ULConst table with a Modify Code of 4.

### EXAMPLE 4

Exemplary Code is set out in Table 9 below:

TABLE 9

| | Line |
|---|---|
| Source Code | No. |
| EXEC SQL | 01743 |
| DECLARE BASEFMCSR CURSOR FOR | 01744 |
| SELECT FM_BASEFORM, FM_CENT_ED_DT, | 01745 |
| FM_FORM_NUM, FM_STATUS, FM_EDDT_IND, | 01746 |
| FM_TITLE, FM_FORM-TYPE, | 01747 |
| FM_LOB_TYPE, FM_STATE_TYPE, FM_MAND_IND, | 01748 |
| FM_CD_IND, FM_SIMULTD_IND, | 01749 |
| FM_AVAIL_DT, FM_SCHD_OBS_DT, FM_LEAVES, | 01750 |
| FM_PAGES, FM_SIM-_ORM_NUM, | 01751 |
| FM_LANG_IND, FM_OUTHOUSE, FM_DISPLAY | 01752 |
| FROM ISO02.DMV00500 | 01753 |
| WHERE FM_BASEFORM =: HOLD_FORM_NUMBER | 01754 |
| AND (FM_STATUS = ‘X’ OR FM_STATUS = ‘H’) | 01756 |
| ORDER BY FM_BASEFORM, FM_CENT_ED_DT DESC; | 01757 |
| | 01758 |

This example is similar to Example 1. SELECT FM_BASEFORM, FM_CENT_ED_DT, FM_FORM_NUM, FM_STATUS, FM_EDDT_IND, FM_TITLE, FM_FORM-TYPE, FM_LOB_TYPE, FM_STATE_TYPE, FM_MAND_IND, FM_CD_IND, FM_SIMULTD_IND, FM_AVAIL_DT, FM_SCHD_OBS_DT, FM_LEAVES, FM_PAGES, FM_SIM_ORM_NUM, FM_LANG_IND, FM_OUTHOUSE, and FM_DISPLAY are entered in the reserved word usage table (ULRwd). The ORDER BY command is entered into the ULCmd table. The literal strings of ‘X’, and ‘H’ are entered in the ULConst table with a Flow code of 1 and Modify code of 4. ISO02.DMV00500, is entered into the DDTbl and ULTbl tables with no alias.

### EXAMPLE 5

Exemplary Code is set out in Table 10 below:

TABLE 10

| Source Code | Line No. |
|---|---|
| EXEC SQL | 01555 |
| FETCH RPTCSR INTO :DCLDMV00620; | 01556 |
| | 01557 |

The EXEC and FETCH commands are entered into the ULCmd table and RPTCSR is entered into the ULVar table with a Flow code of 0 and a Modify code of 6 (used in Call and is a modifier). INTO is put into the ULRwd table. DCLDNW00620 is put into the ULVar table with a code of 5 (used in Call and is modified).

### EXAMPLE 6

Exemplary Code is set out in Table 11 below:

TABLE 11

| Source Code | Line No. |
|---|---|
| EXEC SQL | 01763 |
| FETCH BASEFMCSR INTO | 01764 |
| :FM_BASEFORM, :FM_CENT_ED_DT, | 01765 |
| :FM_FORM_NUM, :FM_STATUS, :FM_EDDT_IND, | 01766 |
| :FM_TITLE, :FM_FORM_TYPE, | 01767 |
| :FM_LOB_TYPE, :FM_STATE_TYPE, | 01768 |
| :FM_MAND_IND, | |
| :FM_CD_IND, :FM_SIMULTD_IND, | 01769 |
| :FM_AVAIL_DT, :FM_SCHD_OBS_DT, | 01770 |
| :FM_LEAVES, | |
| :FM_PAGES, :FM_SIM_FORM_NUM, | 01771 |
| :FM_LANG_IND, :FM_OUTHOUSE, :FM_DISPLAY; | 01772 |
| | 01773 |

This example has more declared variables. BASEFMCSR is put into the ULFId table with a Modify code of 6, and all the declared variables are put into the ULVar table with Modify codes of 5.

### The Viewer(s)

At least one Viewer 70 provides access to the contents of the database 60 (e.g., through graphical representations on a desktop PC) and provides information regarding one or more applications written in one or more language. In a preferred embodiment, each Parser is a computer program dedicated to generating a relational database of source information coded in a particular source language (e.g., COBOL). The relational structure is consistent regardless of the original source language parsed into database. As discussed below, the viewer preferably provides a graphical user interface so that a user can access information relating to one or more applications from one or more databases. Users preferably access this information using standard input devices such as a keyboard, video monitor and preferably a mouse.

Viewers in accordance with the invention can be configured for various platforms including a Personal Computer running a multitasking operating system (e.g., Microsoft Windows, LINUX or the like), workstations and mainframe environments. By specifying one or more application (with associated source code and control information) the invention is operable to present all relevant information, including module-to-module communication, calls made to databases or external files, and variable usage throughout the application. The viewer is generally operable to query the database 60 and provide a text and/or graphical representation of the results.

### Viewer Window Layout

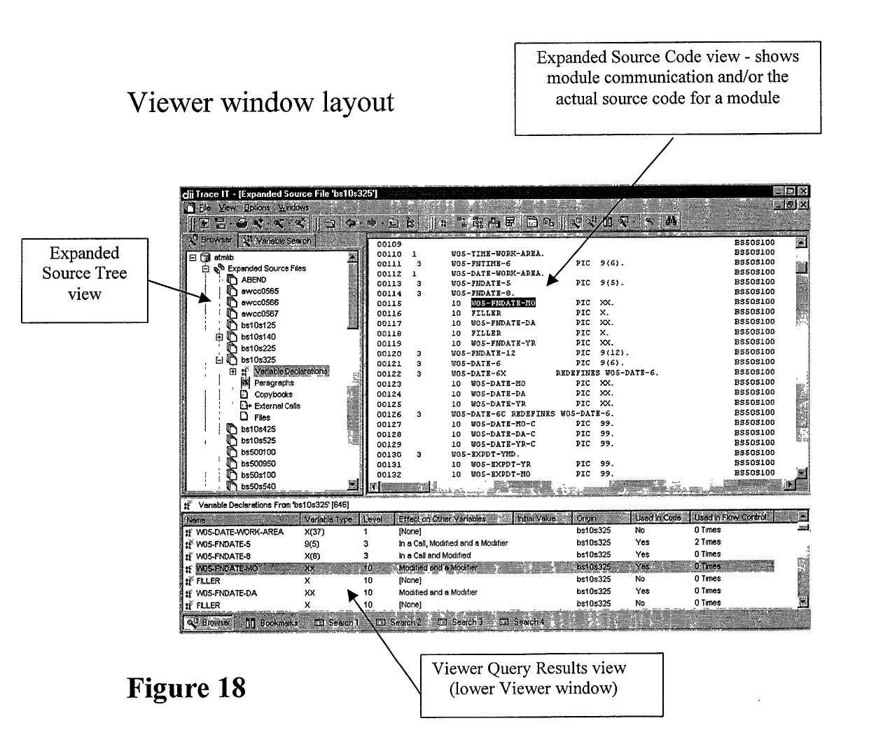

FIG. 18 shows a preferred screen layout for an exemplary Viewer in accordance with the invention. The Expanded Source Tree view window provides a graphical representation of the Expanded Source files associated with a given application (in varying levels of detail). The Expanded Source Code view window shows module communication and/or the actual source code for a given module. In this example, the Expanded Source Code view window shows the variable declarations contained in the bs10s325 module. The Query Results view window (lower view window) shows the results of a query and identifies the program element name as well as other information such as the variable type, the effect on other variables (i.e., derived from the associated Modi code), whether the element is used in code (i.e., derived from the associated Use code) and whether the element is used in Flow Control (i.e., derived from the associated Flow code). Operation of a viewer in accordance with the invention is best understood with reference to the following examples.

### Viewing Module-to-Module Communication

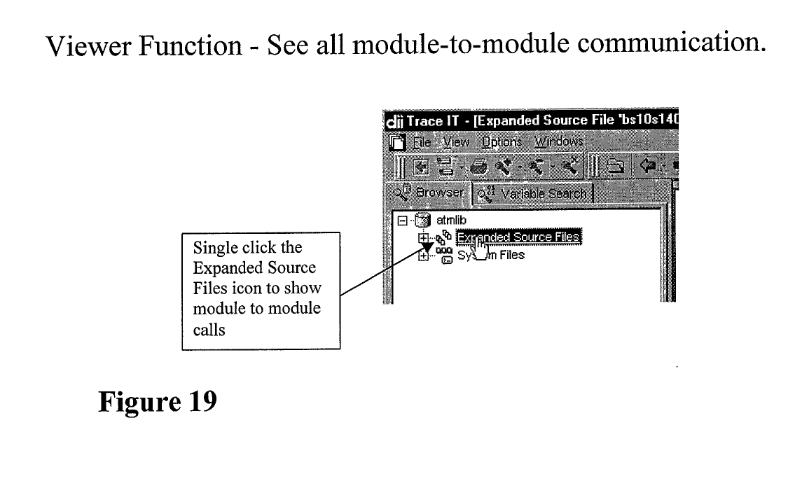

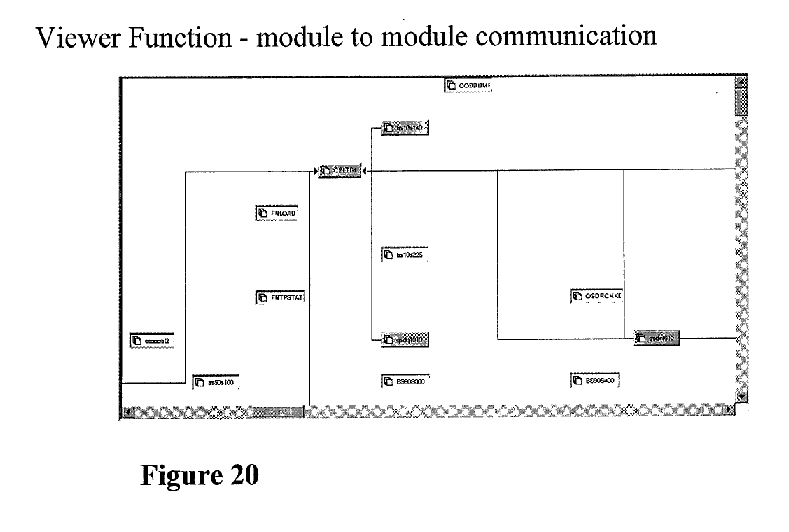

FIG. 19 shows a portion of the Expanded Source Tree view window. A single click on the Expanded Source Files icon brings up the Expanded Source File view as shown in FIG. 20. From this view the user can see all module-to-module communication (e.g., which source modules call other source modules). The user can also zoom in or out on a region or module of interest. Particular modules can be located by entering the name of the module of interest into a “Find” box (not shown) and clicking on the Find button. The Expanded Source File view is changed to show the module of interest in the center of the Expanded Source File view window. When the user positions the cursor over any of the modules or called routines, all calls made by the module are shown with red lines and highlighted boxes.

### Isolating Individual Modules from Other Modules

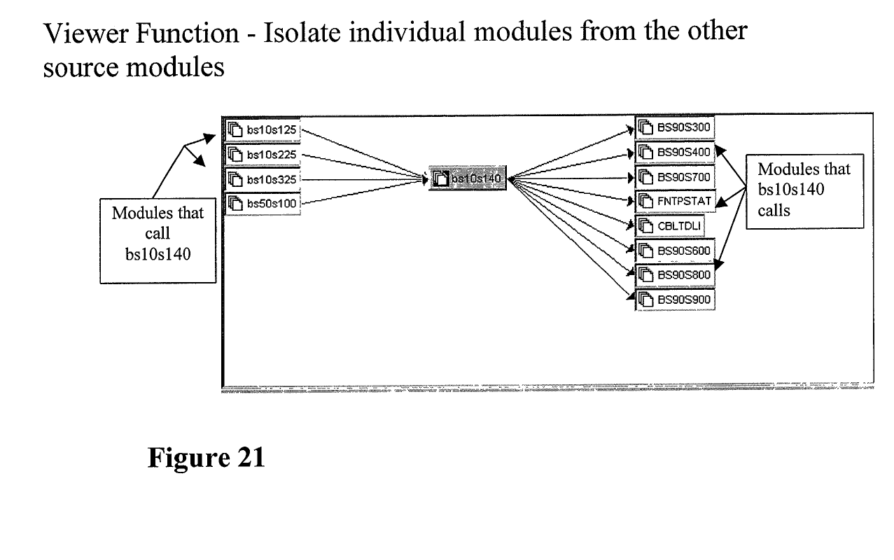

FIG. 21 shows another aspect of the viewer in which individual modules can be isolated from the other source module. A single click (e.g., left mouse button) on any source module shows all of the modules that call that module and all of the calls placed by it. In this example the bs10s140 module is called by four (4) modules and calls eight (8) modules. The individual modules can be “clicked” at any time allowing the user to “walk” the hierarchy of calls. For example, in the diagram above, a user can single click on any module that calls bs10s140. For example, bs10s125. This isolates bs10s125 and shows the calls it makes, and those modules that make calls to bs10s125.

### Expanded Source Code View of a Selected Module

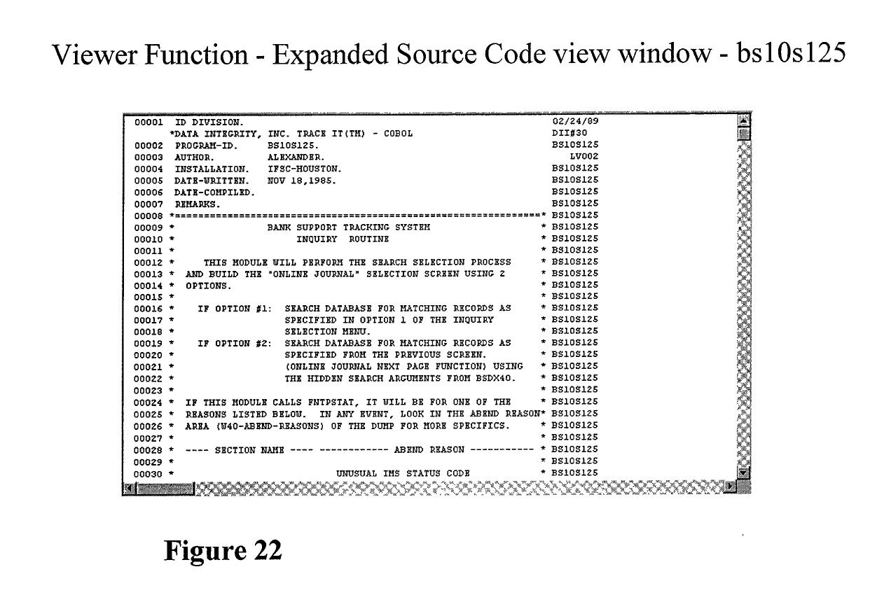

Preferably, a double click on any of the modules displayed allows the user to see the expanded source code for the selected modules (i.e., the source code for the module is loaded into the Expanded Source Code view window). For example, a double click on module bs10s125 causes the source code for this module to appear in the Expanded Source Code view window as shown in FIG. 22. This view allows the user to look directly at the expanded (source & copybook) source information for the module selected. Searches may be performed on any variable, procedure, keyword, call, copybook, character string, etc. that is used inside the source module.

For example, to search on a character string inside the source module, the user clicks on the Find icon (e.g., designated by a pair of binoculars) and types in the string to be searched. The Expanded Source Code view window is then automatically scrolled to the proper location and the search term is highlighted.

### Expanded Source View from Different Perspectives

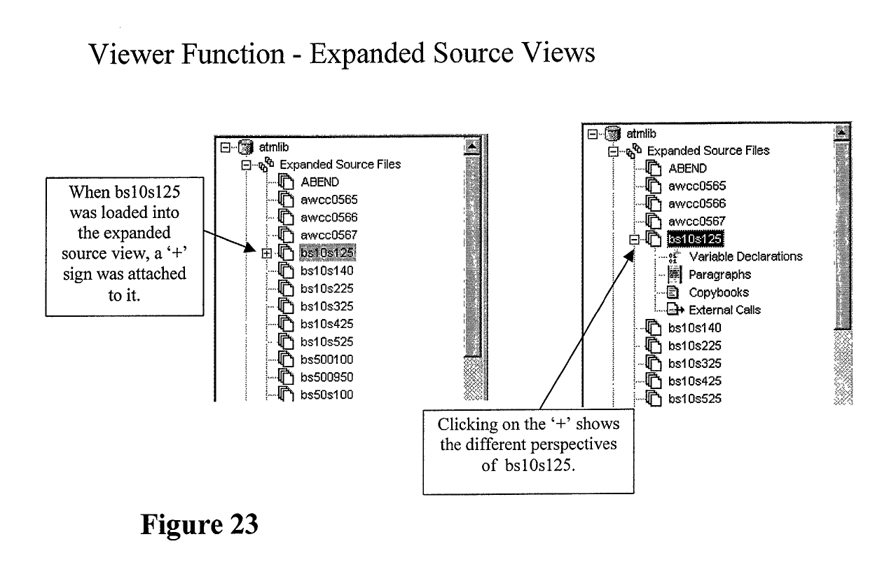

The user can view the expanded source from different perspectives, such as, variables, procedures/paragraphs, copybooks, calls, or external files. When an expanded source file is loaded into the viewer, a ‘+’ sign is shown in the Expanded Source Tree view window to designate file activity. To view all variable declarations for bs10s125, the user single clicks on the Variable Declarations icon underneath bs10s125 as shown in FIG. 23.

### Variable Definitions

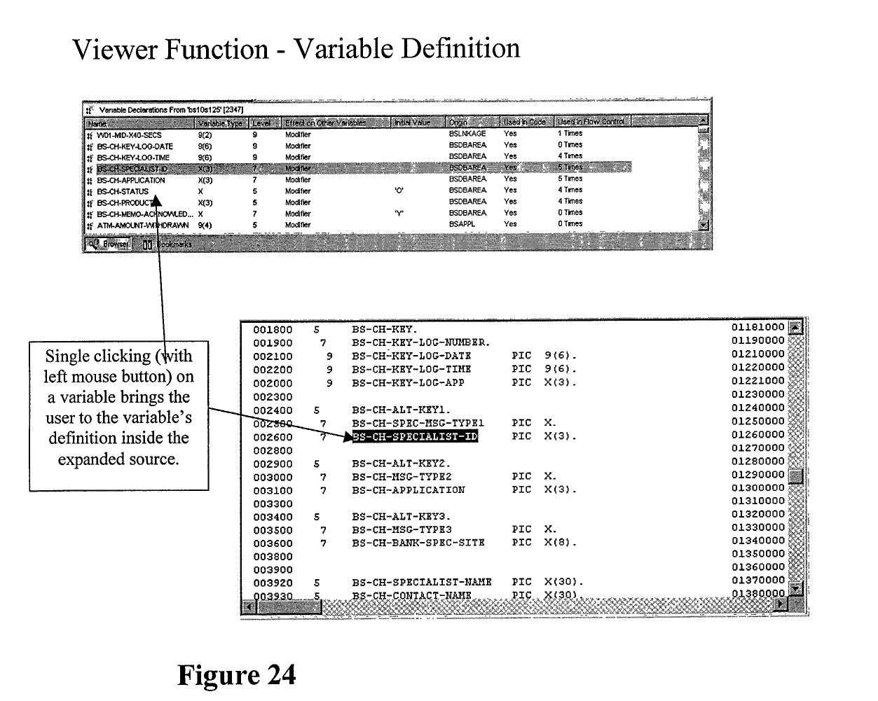

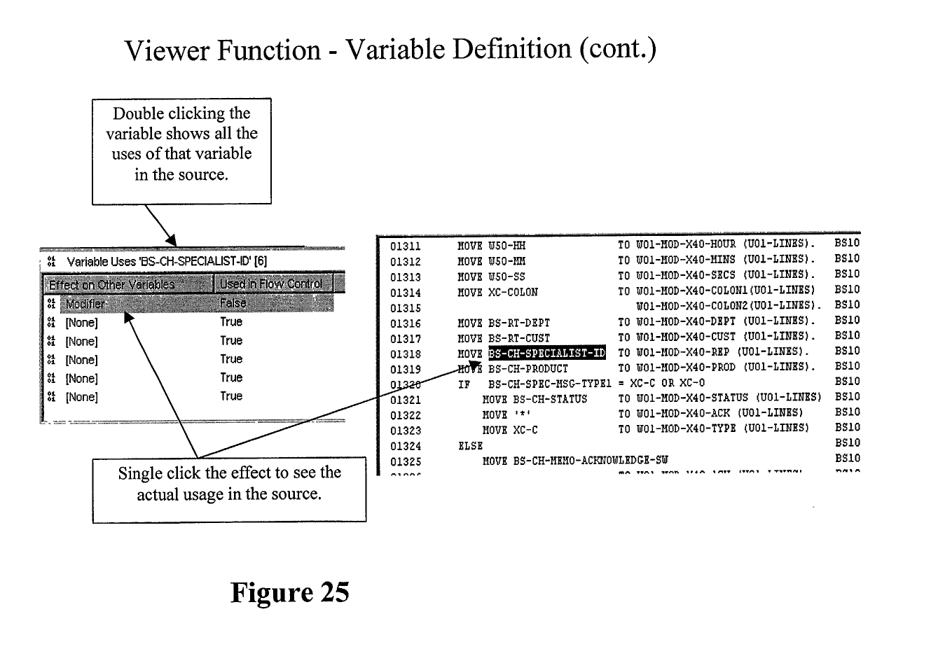

Clicking on Variable Declarations will retrieve all variable information for the module (in this case bs10s125). The variable information is displayed in the lower view window as shown in FIG. 24. Double clicking the variable shows all the uses of that variable in the source. Single clicking the effect displays the actual usage in the source as shown in FIG. 25.

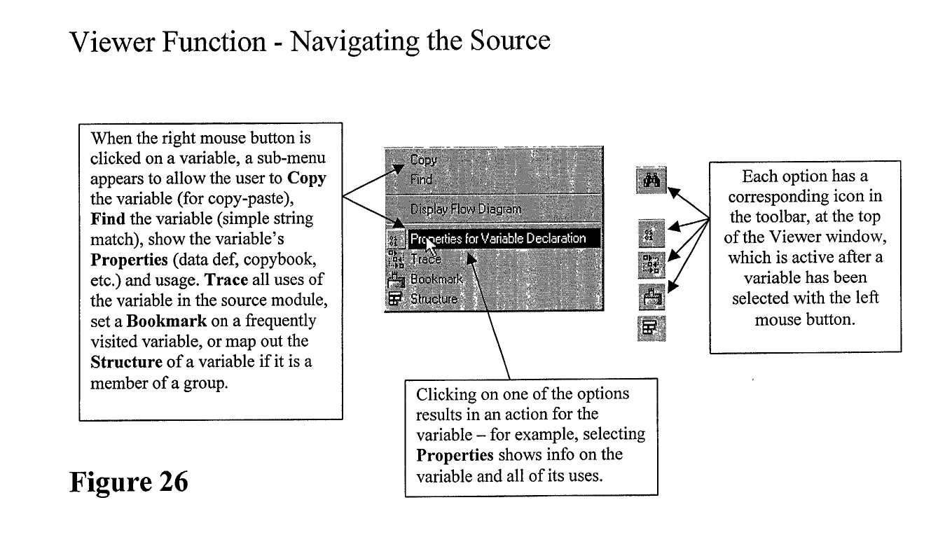

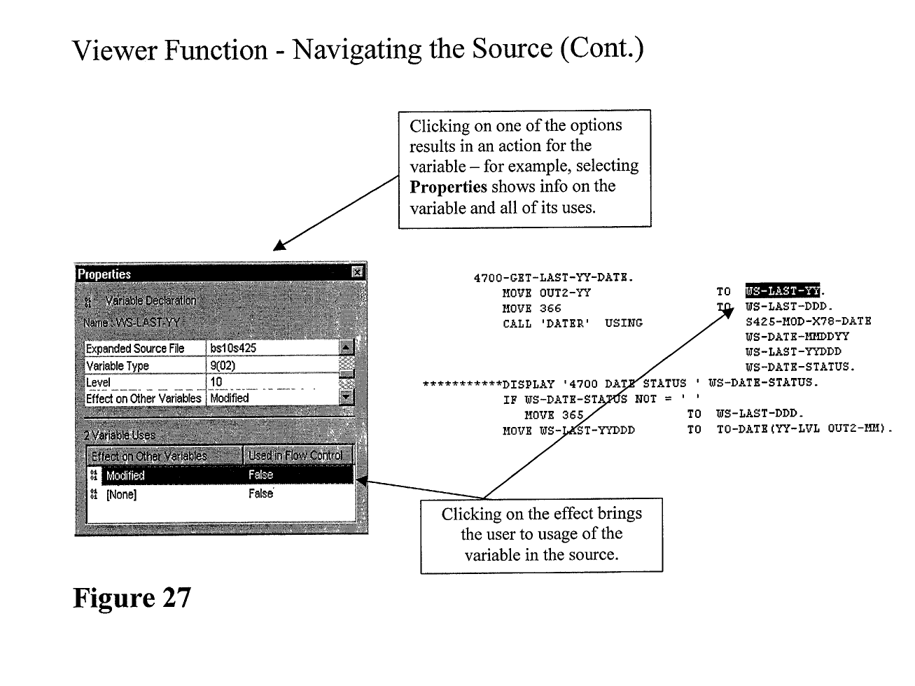

When the right mouse button is clicked on a variable, a sub-menu appears as shown in FIG. 26. The sub menu allows the user to copy the variable (i.e., for copy-paste operations). The user can also find a variable (e.g., via a simple string match). The user can also display the variable's Properties (data definition, copybook, etc.) and usage. The user can also trace all uses of the variable in the source module, set a bookmark on a frequently visited variable, or map out the structure of a variable if it is a member of a group. FIG. 27 shows a Properties display for and exemplary variable. Clicking on the effect displays the usage of the variable in the source code (in the Expanded Source Code view window).

### Variable Details

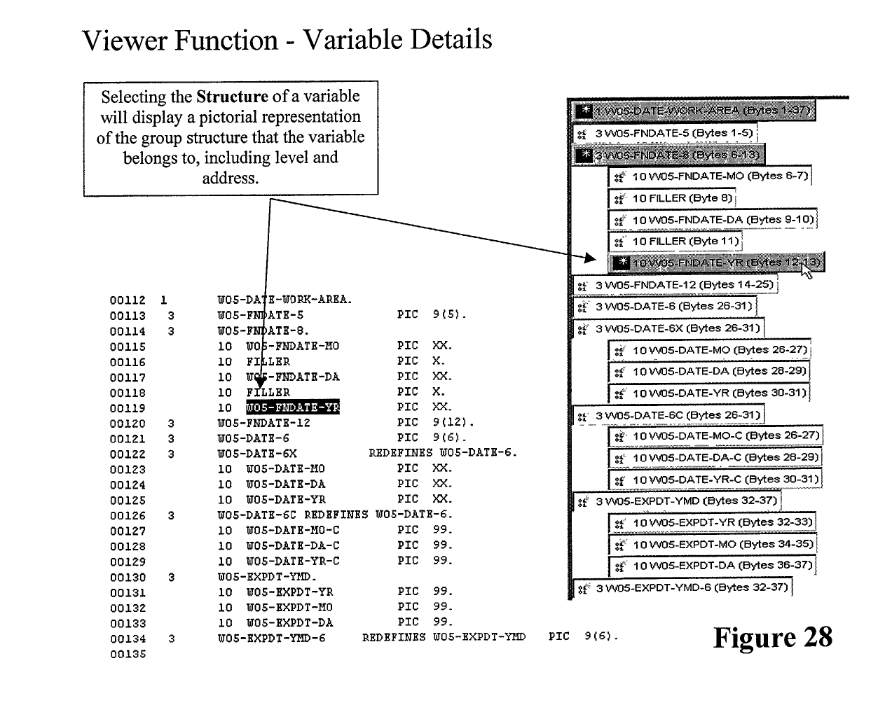

The invention is operable to view and graphically display the structure of group variables, and trace all uses of the variable, in one window. Selecting the structure of a variable displays a pictorial representation of the group structure that the variable belongs to, including level and address as shown in FIG. 28. This information can be used to search on variables, based on their address in a group structure, instead of by name.

### Tracing Usage of a Variable Within a Module

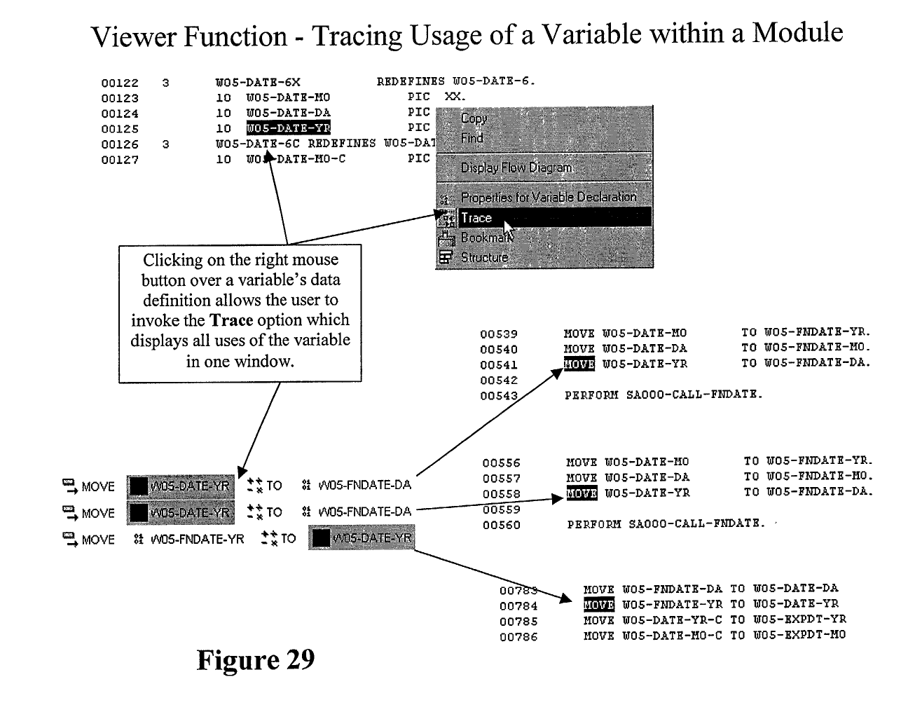

The trace option provides a display of all uses of a variable in a single window. FIG. 29 shows an example in which the trace option is selected for the variable, W05-DATE-YR. This variable is used three times in the source code, each time in a MOVE command. The Trace option shows each occurrence of how the variable is used in the source. To view the line of code for each occurrence, the user double clicks on any of the icons in the Trace display as shown.

### Generating Reports and Output Files

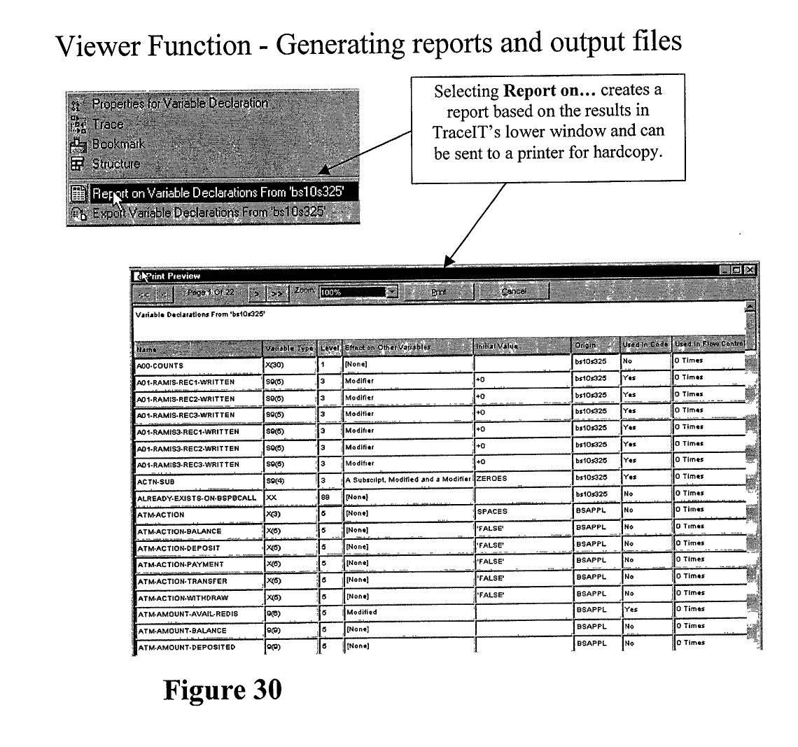

Any of the output displayed in the lower window can be used to generate a report, or output file, to send to a printer or other application. Preferably, an item in the lower window is selected with the right mouse button, and the user is presented with a menu as shown in FIG. 30. The report option preferably sends a Report to an attached printer, network printer or the like. The Export option preferably allows the selected information to be output to a file in a known format (e.g., comma delimited or .xls format). This file can then be imported into other applications such as presentation programs (e.g., Microsoft PowerPoint), word processors (e.g., Microsoft Word), spreadsheet applications (e.g., Microsoft Excel), database programs (e.g., Microsoft Access) and the like. The information can then be used to create more presentations formal documents, reports and the like.

### Other Module Options

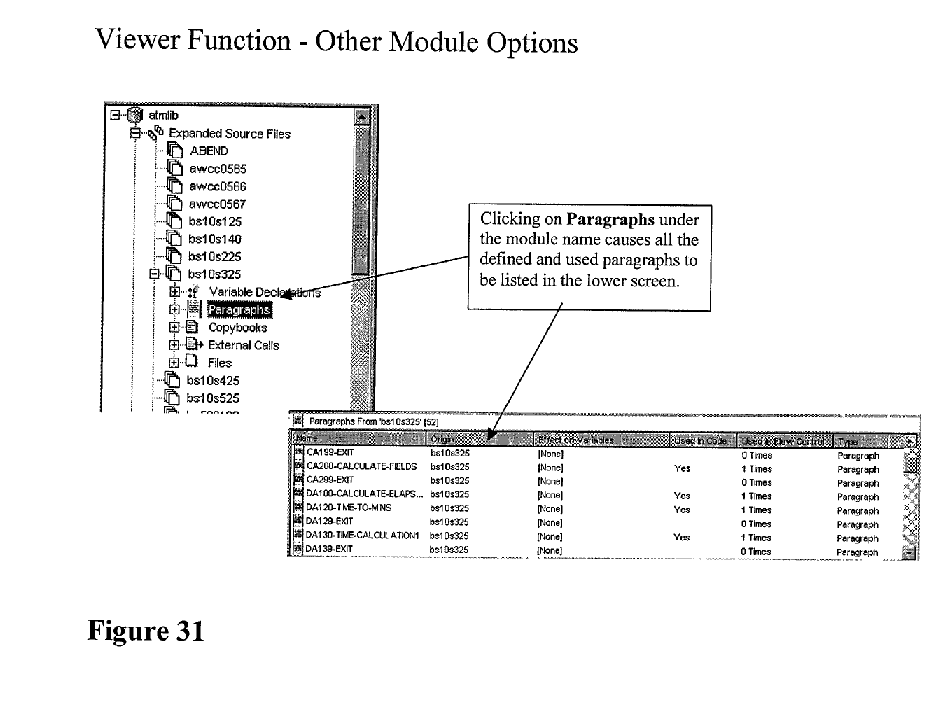

All of the information contained in a source module is stored in the relational database 60. This includes all the defined and used paragraphs/procedures, copybooks used, calls made to other modules, file I/O, etc. The user can access all of this information through the Expanded Source Tree view window as shown in FIG. 31.

Preferably, a single click on any of the paragraphs/procedures in the lower window shows the declaration. A double click preferably shows the uses of the paragraphs. Clicking on any ‘+’ sign expands the view until the actual usage of the Variable, Paragraph, Procedure, Copybook, Call and/or File is reached.

### Navigating to Actual Usage

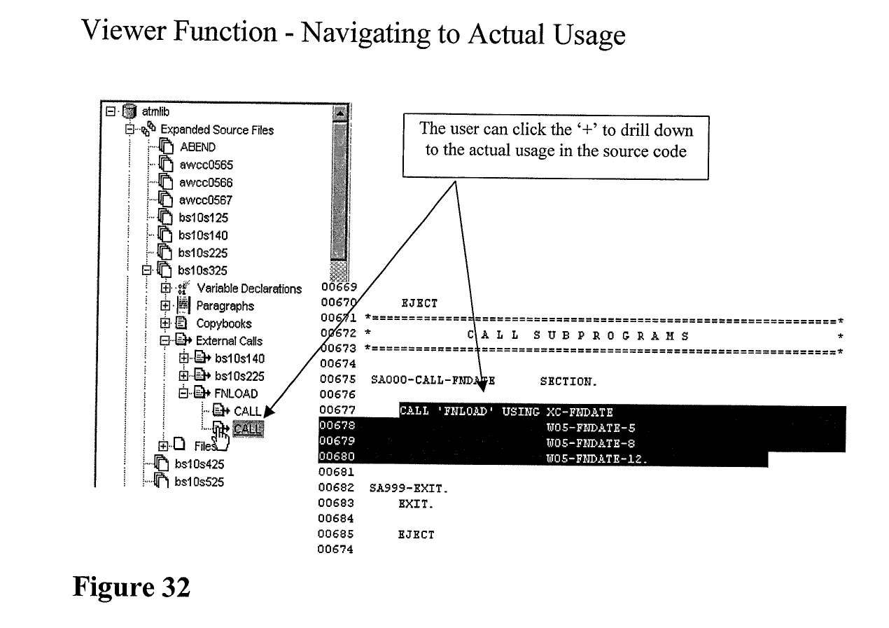

FIG. 32 shows an example in which the bs10s325 icon is clicked to load its source information into the Expanded Source Display view window. A ‘+’ appears next to the bs10s325 icon when the information is loaded. A single click on the ‘+’ reveals the different perspectives for bs10s325. The External Calls icon is clicked to retrieve the “call” information from the relational profile. Clicking on the ‘+’ next to External Calls reveals all the calls made by bs10s325. Clicking on the FNLOAD icon loads all calls made to FNLOAD by bs10s325. A single click on the ‘+’ next to FNLOAD shows all of the calls made to FNLOAD. Selecting any of the CALL icons brings the user to the actual call made in the source code. This procedure works for all program elements (e.g., Variables, Paragraphs, Procedures, Copybooks and/or Files), allowing the user to drill down to any usage of a variable, called module, procedure, copybook, etc.

### Searching Across all Source Modules in an Application

Since all source and copybook information is stored relationally, searches can be made across all the data. The user can search on variables, paragraphs/procedures, copybooks, keywords, constants, commands, database fields, calls, etc.

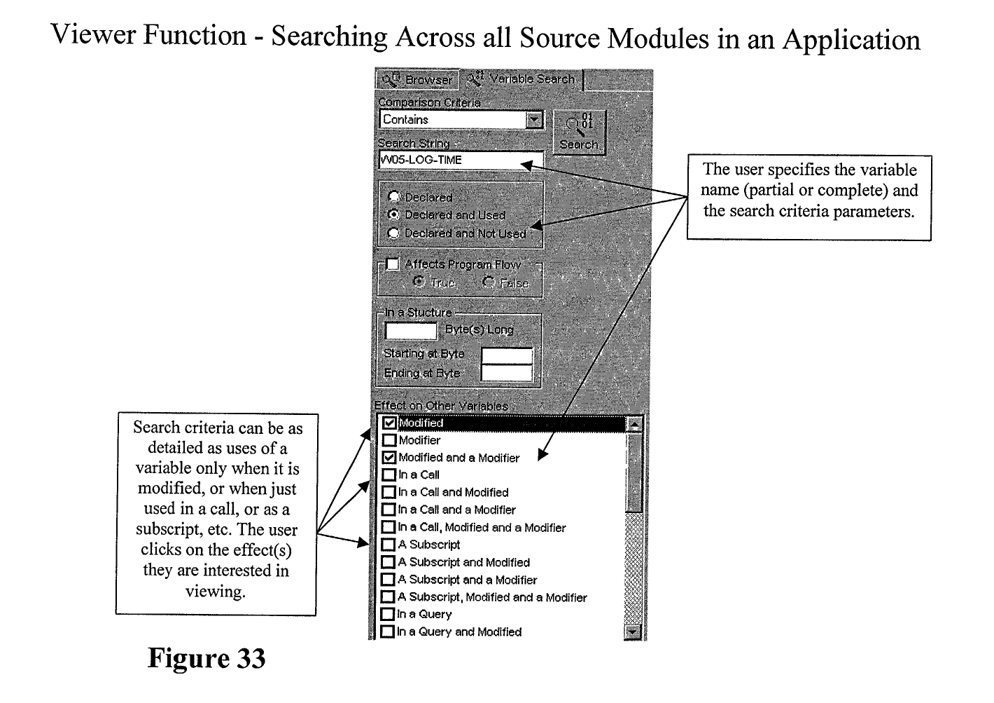

Every use of a variable is cataloged in the database 60. This allows the user to make searches with specific criteria to retrieve only the occurrences of the variable that they are interested in viewing. For example, if a user is trying to find where a variable is being modified incorrectly, they can perform a search for that variable only where it is being modified, instead of every occurrence of that variable. FIG. 33 shows the variable search feature in which the user specifies the variable name (partial or complete) and the search criteria parameters. Search criteria can identify particular uses of a particular variable such as uses of a variable only when it is modified, or when just used in a call, or as a subscript, etc. Preferably, the search criteria are selected by clicking on check boxes associated with the particular effect(s) that the user is interested in viewing. Only a subset of all available effects are shown in FIG. 33. Preferably, all permutations and combinations of effects associated with the Used, Flow and Modify codes, as set out in detail above, are available to the user as search criteria. See Tables 3-5.

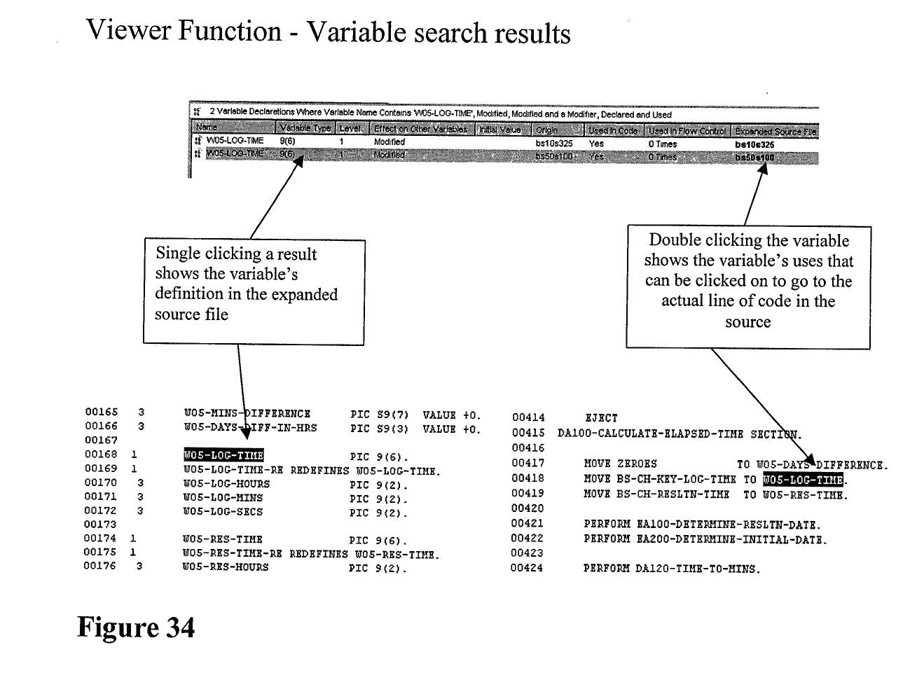

The results from the variable search preferably appear in the lower view window as shown in FIG. 34. The search results can be used to generate a report or output file. They can also be used to navigate to the use of the variable in the application as discussed in above. Single clicking a result shows the variable's definition in the expanded source file. Double clicking the variable shows the variable's uses that can be clicked on to go to the actual line of code in the source.

Searching for a Variable Based on an Address

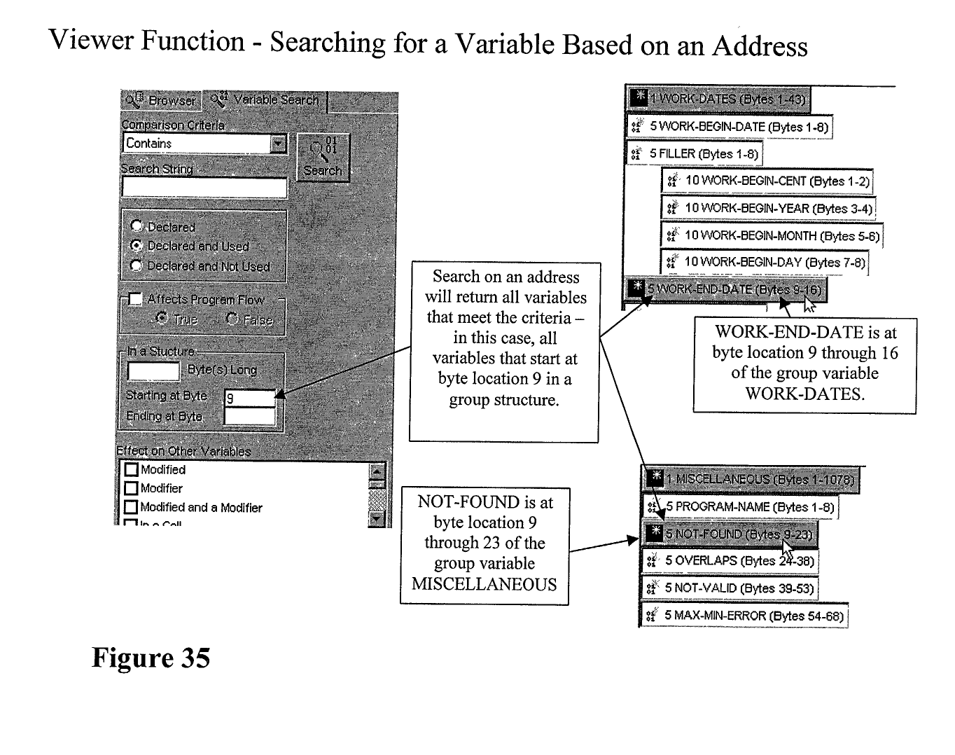

Searches can be made without using a variable's name. For example, a search can be carried out based on a variable's location in a group structure. All of the same criteria for searching on a named (or partially named) variable applies to a search on a variable's address within the group structure. FIG. 35 shows an example in which a search on a particular address returns all variables that meet the criteria—in this case, all variables that start at byte location 9 in a group structure. Preferably, variables can be searched on their starting address, ending address, group variable size, or any combination of the three. This is particularly useful when source modules use the same information but access it through variables that are named differently.

### Searching Across Multiple Applications

The invention is also operable to search for items across multiple applications (assuming the application source and copybook information has been parsed into database 60). This is preferably accomplished through the View->Search option.

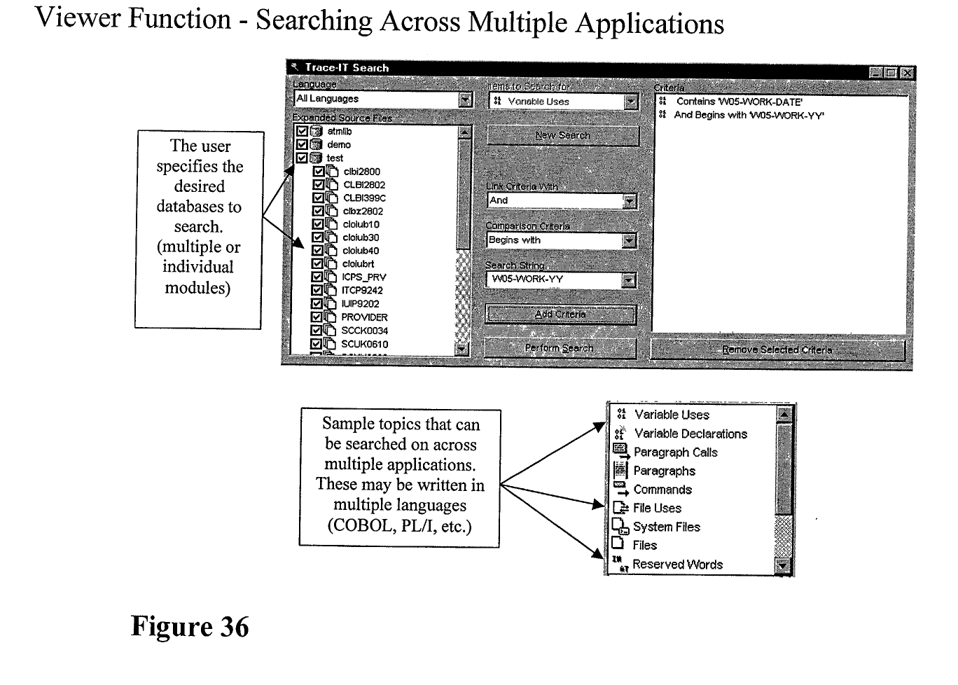

As shown in FIG. 36, the user specifies the desired databases to search. (multiple or individual modules) in the Expanded Source Tree View window. Also shown are sample topics that can be searched on across multiple applications. These may be written in multiple languages (COBOL, PL/I, etc.). The user can build a query based on variables, DB field uses, external file calls, keywords, etc. These queries are built by linking search criteria together (e.g., with Boolean logic) until the exact search criteria is constructed. Then the Perform Search button is clicked to run the search.

### Multiple Database Search Results

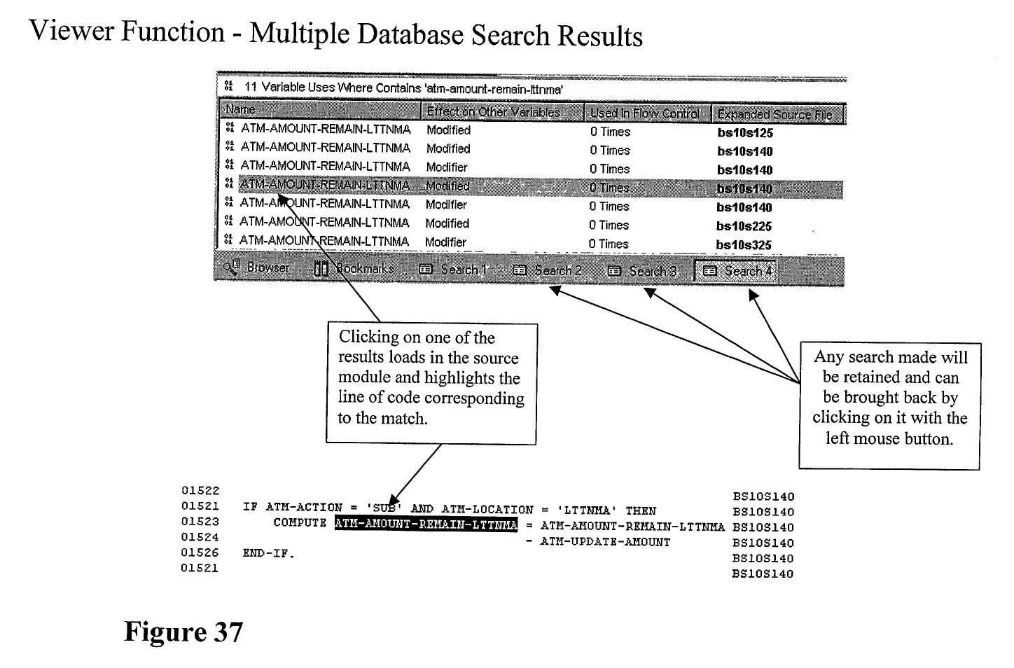

Results from searches across multiple databases preferably appear in the lower view window. The search returns the individual occurrences for each match to the criteria. Clicking on any of the individual occurrences opens up the correct source module and highlights the line of code corresponding to the match as shown in FIG. 37. Clicking on one of the results loads the appropriate source module and highlights the line of code corresponding to the match. All previously performed searches are preferably retained and are selectable by a single click on the appropriate Icon as shown. The search results can also be used to generate a report or an output file that can be exported as discussed above.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for analyzing at least one application having at least one source code file, the system comprising a parser operable to read the source code file and identify at least one of a variable, constant, command, instruction, function, database table and database field associated with the source code file, the parser being operable to quantify a role for each variable, constant, function, database table and database field identified in the source code file.

2. The system of claim 1 comprising a database operable to store data derived from the source code file, wherein the parser is operable to read the source code file and write data derived from the source code file into the database.

3. The system of claim 1 wherein the parser is operable quantify whether each variable, constant, function, database table and database field is a modifier, modified, used in a call, used as subscript, and used in a database query.

4. The system of claim 3 wherein the parser is operable to assign at least one of a use code, modification code and a flow code for each variable, constant, function, database table and database field identified in the source code file.

5. The system of claim 2 comprising at least one viewer operable to query the database, read query results and display information relating to at least a portion of the query results.

6. The system of claim 5 wherein the viewer is operable to display information relating to communication between at least two modules within the source code file.

7. The system of claim 5 wherein the viewer is operable to display information that isolates an individual source module from other source modules within the source code file.

8. The system of claim 5 wherein the viewer is operable to display the source code for at least one module within the source code file.

9. The system of claim 5 wherein the viewer is operable to display source code organized from different perspectives including at least two of procedures, paragraphs, copybooks, calls, and external files.

10. The system of claim 5 wherein the viewer is operable to display information relating to at least one variable recited in the source code file.

11. The system of claim 5 wherein the viewer is operable to display information relating to the structure of at least one group of variables within the source code file.

12. The system of claim 5 wherein the viewer is operable to display information relating to use of at least one variable within the source code file.

13. The system of claim 5 wherein the viewer is operable to display information relating to at least one module based on different perspective including at least two of variable declarations, copybooks, external calls and files.

14. The system of claim 5 wherein the viewer is operable to display information associated with at least one module within the source code file based on at least one of a variable, paragraph, procedures, copybook, keyword, constant, command, database field and call.

15. The system of claim 5 wherein the viewer is operable to display information associated with at least one module within the source code file based on a variable name.

16. The system of claim 5 wherein the viewer is operable to display information associated with at least one module within the source code file based on a location of a variable within a group structure.

17. The system of claim 5 wherein the data derived from the source code file in the database relates to a plurality of applications having a plurality of associated source code files.

18. A method for analyzing at least one application having at least one source code file, the method comprising:
identifying at least one of a variable, constant, command, instruction, function, database table and database field associated with the source code file; and
quantifying a role for each variable, constant, function, database table and database field identified in the source code file.

19. The method of claim 18 comprising storing data derived from the source code file in a database.

20. The method of claim 18 comprising quantifying whether each variable, constant, function, database table and database field is a modifier, modified, used in a call, used as subscript, and used in a database query.

21. The method of claim 18 comprising assigning at least one of a use code, modification code and a flow code for each variable, constant, function, database table and database field identified in the source code file.

22. The method of claim 19 comprising querying the database, reading query results and displaying at least a portion of the query results.

23. The method of claim 22 wherein the query results relate to communication between at least two modules within the source code file.

24. The method of claim 22 wherein the query results relate to information that isolates an individual source module from other source modules within the source code file.

25. The method of claim 22 wherein the query results relate to source code for at least one module within the source code file.

26. The method of claim 22 wherein the query results relate to source code organized from different perspectives including at least two of procedures, paragraphs, copybooks, calls, and external files.

27. The method of claim 22 wherein the query results relate to at least one variable in the source code file.

28. The method of claim 22 wherein the query results relate to the structure of at least one group of variables within the source code file.

29. The method of claim 22 wherein the query results relate to use of at least one variable within the source code file.

30. The method of claim 22 wherein the query results relate to a selected module based on different perspective including at least one of variable declarations, copybooks, external calls and files.

31. The method of claim 22 wherein the query results relate to information associated with at least one module within the source code file based on at least one of a variable, paragraph, procedures, copybook, keyword, constant, command, database field and call.

33. The method of claim 22 wherein the query results relate to information associated with at least one module within the source code file based on a variable name.

34. The method of claim 22 wherein the query results relate to information associated with at least one module within the source code file based on a location of a variable within a group structure.

35. The method of claim 22 wherein the query results relate to a plurality of applications having a plurality of associated source code files.

36. A system for analyzing at least one application having at least one source code file, the system comprising a load program, source retrieval program, a source file manager and a parser with an associated database.

37. The system of claim 36 wherein the load program is operable to initiate execution of the source retrieval program.

38. The system of claim 36 wherein the source retrieval program is operable to gather at least one source code file.

39. The system of claim 36 wherein the source retrieval program is operable to gather at least one source code file and transmit the source code file to the source file manager.

40. The system of claim 36 wherein the source file manager is operable to transmit the source code file to the parser.

41. The system of claim 36 wherein the parser is operable to operable to read the source code file and write data derived from the source code file into the database.

42. The system of claim 36 comprising at least one viewer operable to query the database, read query results and display information relating to at least a portion of the query results.

43. The system of claim 36 wherein the parser is operable to read the source code file and identify at least one of a variable, constant, command, instruction, function, database table and database field associated with the source code file, the parser being operable to quantify a role for each variable, constant, function, database table and database field identified in the source code file.

44. The system of claim 36 wherein the parser is operable quantify whether each variable, constant, command, instruction, function, database table and database field is a modifier, modified, used in a call, used as subscript, and used in a database query.

45. A method for analyzing at least one application having at least one source code file, the method comprising:
automatically gathering all source code files associated with the a least one application; and
automatically parsing all source code files associated with the a least one application.

46. The method of claim 45 comprising storing data derived from the source code file in a database.

47. The method of claim 45 wherein parsing comprises identifying at least one of a variable, constant, command, instruction, function, database table and database field associated with each source code file

48. The method of claim 47 wherein parsing comprises quantifying a role for each variable, constant, function, database table and database field identified in each source code file.

49. The method of claim 45 wherein parsing comprises quantifying whether each variable, constant, function, database table and database field is a modifier, modified, used in a call, used as subscript, and used in a database query.

50. The method of claim 45 wherein parsing comprises assigning at least one of a use code, modification code and a flow code for each variable, constant, function, database table and database field identified in the source code file.

51. The method of claim 45 comprising querying the database, reading query results and displaying at least a portion of the query results.
